(19) United States
(12) Patent Application Publication
(10) Pub. No.: US 2013/0293333 A1
(43) Pub. Date: Nov. 7, 2013

(54) DISCONTINUOUS LOOP ANTENNAS SUITABLE FOR RADIO-FREQUENCY IDENTIFICATION (RFID) TAGS, AND RELATED COMPONENTS, SYSTEMS, AND METHODS

(71) Applicants: Jeevan Kumar Vemagiri, Peoria, AZ (US); Richard Edward Wagner, Painted Post, NY (US); Matthew Scott Whiting, Lawrenceville, PA (US)

(72) Inventors: Jeevan Kumar Vemagiri, Peoria, AZ (US); Richard Edward Wagner, Painted Post, NY (US); Matthew Scott Whiting, Lawrenceville, PA (US)

(21) Appl. No.: 13/826,407

(22) Filed: Mar. 14, 2013

Related U.S. Application Data
(60) Provisional application No. 61/640,800, filed on May 1, 2012.

(51) Int. Cl. H01F 38/14

(52) U.S. Cl. CPC H01F 38/14
USPC 336/105

(57) ABSTRACT

Discontinuous loop antennas and related components, radio-frequency identification (RFID), tags, systems, and methods are disclosed. A discontinuous loop antenna is an antenna loop structure that includes a discontinuity portion. The discontinuous loop antenna can be coupled to an RFID chip to provide an RFID tag. The discontinuity portion decreases the loop inductance and tag capacitance, thus enabling the discontinuous loop antenna to have significantly larger loop area while still matching the chip impedance, resulting in dramatic increases in near-field sensitivity. Increased near-field sensitivity provides increased power harvesting efficiency during near-field coupling. As one non-limiting example, an RFID tag having a discontinuous loop antenna may achieve significantly more power harvesting from a RF signal than an RFID tag having a continuous loop antenna tuned to the same or similar resonant frequency. The discontinuity portion can be trimmed after fabrication allowing the resonant frequency of the RFID tag to be tuned.

### PRIORITY APPLICATION

The present application claims priority to U.S. Provisional Patent Application Ser. No. 61/640,800 filed on May 1, 2012 and entitled “Discontinuous Loop Antennas Suitable for Radio-Frequency Identification (RFID) Tags, and Related Components, Systems, and Methods,” which is incorporated herein by reference in its entirety.

### BACKGROUND

1. Field of the Disclosure

The technology of the disclosure is related to antennas that may be suitable for radio-frequency (RF) identification (RFID) antennas, tags or transponders, including passive RFID tags.

2. Technical Background

It is well known to employ radio frequency (RF) identification (RFID) transponders to identify articles of manufacture. RFID transponders are often referred to as “RFID tags.” For example, FIG. 1 is a diagram of an exemplary RFID system 10 that includes a passive RFID tag 12. The passive RFID tag 12 includes an integrated circuit (IC) 14 that is communicatively coupled to an antenna 16. The IC 14 may also be coupled to memory 18. An identification number or other characteristic is stored in the IC 14 or memory 18 coupled to the IC 14. The passive RFID tag 12 is typically included in a body 20 or other enclosure. The identification number can be provided to another system, such as the RFID reader 22, to provide identification information for a variety of purposes. The passive RFID tag 12 does not include a transmitter. The antenna 16 of the passive RFID tag 12 receives a wireless RF signal 24, also known as an “interrogation signal,” from a transmitter 26 in the RFID reader 22. The passive RFID tag 12 harvests energy from the electro-magnetic field of a wireless RF signal 24 to provide power to the IC 14 for passive RFID tag 12 operation. The RFID tag 12 can respond to receipt of the wireless RF signal 24, including providing identification information, via backscatter modulation communications, as an example.

The performance of a passive RFID system hinges on the performance of the passive RFID tags in the system. To increase performance, the passive RFID tags should maximize power harvesting from interrogation signals for RFID tag operation. A threshold amount of power transfer to a passive RFID tag is necessary for passive RFID tag operation. The amount of power transferred to a passive RFID tag also affects the communication range of the passive RFID tag. One method of maximizing power harvesting is to minimize power transfer losses due to RFID tag impedance mismatches. An RFID tag antenna possesses inherent impedance (i.e., resistive and reactive) characteristics such that when matched appropriately to the RFID chip impedance (i.e., a load), the signal energy received by the antenna can be efficiently transferred to the RFID integrated circuit (IC) chip (“RFID chip”) for operation. An impedance mismatch will result in the signal energy being reflected (not absorbed) by the RFID chip to a degree commensurate with the amount of mismatch. Further, if the passive RFID tag is located in an array or cluster of other passive RFID tags, the RFID impedance mismatch may be compounded. The energy from an interrogation signal may be shared among multiple passive RFID tags in the cluster thereby providing less power transfer to each passive RFID tag. To further compound the impedance matching problem, RFID chip impedance varies based on the frequency of the received signal by the passive RFID tag antenna.

Based on an RFID tag antenna classification by radiation coupling mode, the RFID tag antenna can be near-field coupling or far-field coupling. If short range RFID tag communication capabilities (e.g., less than one wavelength away from an RFID reader) are desired, an RFID tag antenna classified for near-field coupling can be employed. Near-field coupling involves coupling power predominantly inductively through the magnetic field (“H-field”) of a signal which is not radiating, and has strong reactive effects for power harvesting. However, near-field effects decrease in power quickly with distance. Thus, a near-field RFID tag needs to remain close to an RFID reader to harvest power from signal energy for effective RFID tag operations. If longer range RFID tag communications capabilities (e.g., greater than two wavelengths away from an RFID reader) are desired, an RFID tag antenna classified for far-field coupling can be employed. Far-field coupling involves power coupling dominantly via electric field (“E-field”) radiation, which decreases less quickly with distance than near-field coupling. Thus, with either choice of an RFID antenna classified as near-field or far-field coupling, a tradeoff exists as to whether power is predominantly harvested from the E-field or H-field components of signal power.

### SUMMARY OF THE DETAILED DESCRIPTION

Embodiments disclosed in the detailed description include discontinuous loop antennas. Related components, tags, systems, and methods are also disclosed. A discontinuous loop antenna is an antenna loop structure that includes a discontinuity portion. The discontinuous loop antenna can be coupled to an RFID chip to provide an RFID tag as a non-limiting example. The discontinuity portion allows the discontinuous loop antenna to have magnetic field sensitivity at greater than one wavelength of the discontinuous loop antenna. Thus, the discontinuous loop antenna has significantly increased near-field sensitivity over other antennas. Increased near-field sensitivity provides increased power harvesting efficiency during near-field coupling. As one non-limiting example, an RFID tag having a discontinuous loop antenna may achieve up to one hundred (100) times more power harvesting from a radio-frequency (RF) signal than an RFID tag having a continuous loop antenna tuned to the same or similar resonant frequency.

In this regard, a discontinuity portion provided in the antenna loop structure introduces a discontinuity capacitor into the antenna loop structure. The introduction of the discontinuity capacitor decreases the inductance in the antenna loop structure. As a result, the inductance of the antenna loop structure can be increased from the decreased inductance provided by the discontinuity portion by increasing the loop area of the antenna loop structure. As a result of this increased loop area, the discontinuous loop antenna provides increased near-field sensitivity for increased power harvesting efficiency during near-field coupling. Providing increased near-field sensitivity for increased power harvesting efficiency during near-field coupling may allow an RFID tag to be unaffected in certain environments or mediums that otherwise may not be possible. Also by increasing the inductance of the discontinuous loop antenna, impedance matching to the RFID chip can be retained, as would have been achieved with a smaller loop area continuous loop antenna structure.

Further, because the capacitance is provided through a discontinuity portion in the loop antenna structure, the discontinuity capacitance can be adjusted to be lowered to tune the resonant frequency of the discontinuous loop antenna. This is achieved from the characteristic that the discontinuity capacitor, by being in series and smaller than the fixed capacitance of the RFID chip, dominates and lowers the overall capacitance of the RFID tag. Thus, the RFID tag having a discontinuous loop antenna can be tuned to match different frequency bands and/or be applied to articles where tuning may be required for performance.

Several methods can be employed to increase the loop area of the discontinuous loop antenna. One exemplary method includes increasing length and/or width of the antenna loop structure. Another exemplary method includes increasing the overlap of the antenna loop structure forming the discontinuity portion in the discontinuous loop antenna. These methods may be provided during the design phase of the discontinuous loop antenna. However, because of the discontinuity portion provided in the discontinuous loop antenna, it is also feasible to change the inductance and corresponding center frequency of the discontinuous loop antenna even after antenna fabrication is complete. The discontinuous loop antenna resonant frequency can be tuned depending on application.

In this regard, in one embodiment, a discontinuous loop antenna is provided. The discontinuous loop antenna comprises a loop conductor. A discontinuity portion is disposed in the loop conductor forming a discontinuity capacitor in the loop conductor. In one embodiment, the discontinuity portion is formed by a single discontinuity.

In another embodiment, a radio-frequency identification (RFID) tag is provided. The RFID tag is comprised of a RFID integrated circuit (IC) chip configured to receive RF power. The RFID tag is also comprised of a discontinuous loop antenna electrically coupled to the RFID IC chip. The discontinuous loop antenna is configured to collect RF power from a received RF signal, and provide the RF power to the RFID IC chip to power the RFID IC chip. The discontinuous loop antenna may comprise a discontinuity portion disposed in the loop conductor forming a discontinuity capacitor in the loop conductor.

In another embodiment, a method of receiving radio-frequency (RF) signals by a RFID tag antenna is provided. The method comprises receiving a RF signal through a discontinuous loop antenna. The method also comprises providing the RF signal to an RFID IC chip. The method also comprises powering the RFID IC chip with the RF energy from the RF signal. The method also comprises demodulating RF communications in the RF signal in the RFID IC chip. The discontinuous loop antenna may comprise a discontinuity portion disposed in the loop conductor forming a discontinuity capacitor in the loop conductor. Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a diagram of an exemplary RFID tag interrogated by an interrogation signal from an RFID reader;

FIG. 2 is a diagram of an exemplary discontinuous loop antenna having a discontinuous portion formed by an overlap provided in the loop conductor;

FIG. 3A is an exemplary plot graph of discontinuity capacitance, RFID chip capacitance, and total RFID tag capacitance when employing a discontinuous loop antenna in an RFID tag;

FIGS. 3B and 3C are an exemplary discontinuous loop antenna having markers for tuning the resonant frequency of the discontinuous loop antenna and a graph of exemplary tunings for the discontinuous loop antenna, respectively;

FIG. 4 is a diagram of another exemplary discontinuous loop antenna having a discontinuous portion formed by an overlap provided in the loop conductor;

FIGS. 5A and 5B are diagrams of exemplary discontinuous loop antennas having a discontinuity portion formed by an end gap provided in a loop conductor;

FIGS. 6A and 6B are diagrams of other exemplary discontinuous loop antennas having discontinuity portions formed by inter-digitated portions provided in a loop conductor;

FIGS. 7A and 7B are equivalent circuit diagrams of exemplary representations of discontinuous loop antennas coupled to an RFID chip without and with electrostatic discharge shunts, respectively;

FIGS. 8A and 8B are diagrams of an exemplary continuous loop antenna and an exemplary discontinuous loop antenna;

FIG. 8C is a plot graph comparing the power couplings of the continuous loop antenna and the discontinuous loop antenna in FIGS. 8A and 8B, respectively, in a magnetic field;

FIGS. 9A and 9B are diagrams of other exemplary discontinuous loop antennas having varied discontinuity gaps;

FIG. 9C is an exemplary plot graph comparing the power couplings of the discontinuous loop antennas in FIGS. 9A and 9B, respectively, in a magnetic field;

FIGS. 10A and 10B are diagrams of other exemplary discontinuous loop antennas having varied antenna loop conductor widths;

FIG. 10C is an exemplary plot graph comparing the power couplings of the discontinuous loop antennas in FIGS. 10A and 10B, respectively, in a magnetic field;

FIGS. 11A and 11B are diagrams of other exemplary discontinuous loop antennas having varied antenna loop widths at the discontinuity;

FIG. 11C is an exemplary plot graph comparing the power couplings of the discontinuous loop antennas in FIGS. 11A and 11B, respectively, in a magnetic field;

FIGS. 12A and 12B are diagrams of other exemplary discontinuous loop antennas having inner and outer electrostatic discharge (ESD) loops, respectively;

FIG. 12C is an exemplary plot graph comparing the power couplings of the discontinuous loop antennas in FIGS. 12A and 12B, respectively, in a magnetic field;

FIGS. 13A and 13B are diagrams of other exemplary discontinuous loop antennas having varied form factors;

FIG. 13C is an exemplary plot graph comparing the power couplings of the discontinuous loop antennas in FIGS. 13A and 13B, respectively, in a magnetic field;

FIG. 13D is an exemplary plot graph comparing the power couplings of the discontinuous loop antennas in FIGS. 13A and 13B, respectively, in an electric field;

FIGS. 14A-14C are diagrams of other exemplary discontinuous loop antennas having the same form factor antenna loop size tuned for different center frequencies;

FIG. 14D is an exemplary plot graph comparing the power couplings of the discontinuous loop antennas in FIGS. 14A-14C, respectively, as a function of frequency;

FIG. 15A is a diagram of another exemplary discontinuous loop antenna sized for space constrained applications realized by overlapping discontinuous loop conductors and increasing conductor lengths;

FIG. 15B is an exemplary plot graph illustrating the power coupling of the discontinuous loop antenna in FIG. 15A in a magnetic field;

FIGS. 16A-16C are diagrams of other exemplary discontinuous loop antennas having the same form factor of the discontinuous loop antenna in FIG. 15A tuned for different center frequencies;

FIG. 16D is an exemplary plot graph comparing the power couplings of the discontinuous loop antennas in FIGS. 16A-16C, respectively, as a function of frequency;

FIGS. 17A-17C are diagrams of other exemplary discontinuous loop antennas having the same form factor of the discontinuous loop antenna in FIG. 17A designed for different exemplary applications;

FIG. 17D is an exemplary plot graph comparing the power couplings of the discontinuous loop antennas in FIGS. 17A-17C, respectively, as a function of frequency;

FIG. 18A is a diagram of the discontinuous loop antenna in FIG. 15A;

FIG. 18B is a diagram of another exemplary discontinuous loop antenna having improved power coupling using circumference conductors;

FIG. 18C is an exemplary plot graph comparing the power couplings of the discontinuous loop antennas in FIGS. 18A and 18B, respectively, in a magnetic field;

FIGS. 19A and 19B are diagrams of other exemplary small-sized continuous and discontinuous loop antennas, respectively;

FIG. 19C is an exemplary plot graph comparing the power couplings of the continuous and discontinuous loop antennas in FIGS. 19A and 19B, respectively, in a magnetic field;

FIGS. 20A and 20B are diagrams of other exemplary small-sized continuous and discontinuous loop antennas, respectively;

FIG. 20C is an exemplary plot graph comparing the power couplings of the continuous and discontinuous loop antennas in FIGS. 20A and 20B, respectively, in a magnetic field;

FIGS. 21A and 21B are diagrams of other exemplary small-sized continuous loop antenna and a discontinuous loop antenna with outer ESD shunt, respectively;

FIG. 21C is an exemplary plot graph comparing the power couplings of the continuous and discontinuous loop antennas in FIGS. 21A and 21B, respectively, in a magnetic field;

FIGS. 22A and 22B are diagrams of other exemplary small-sized continuous loop antenna and a discontinuous loop antenna with inner ESD shunt, respectively; and

FIG. 22C is an exemplary plot graph comparing the power couplings of the continuous and discontinuous loop antennas in FIGS. 22A and 22B, respectively, in a magnetic field.

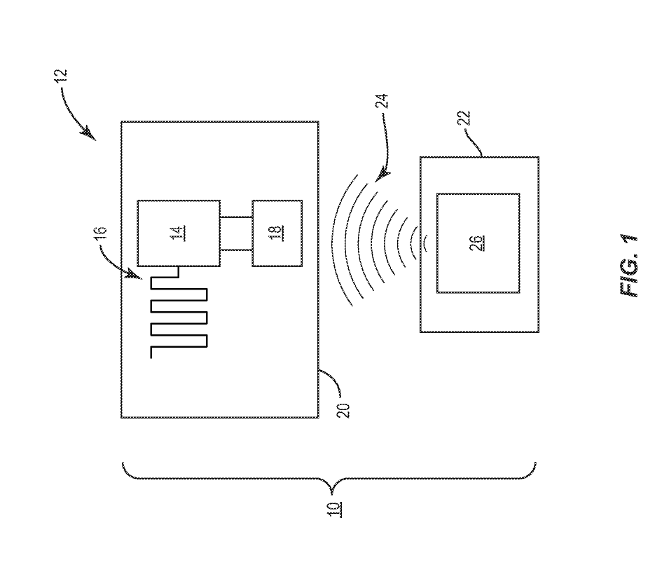

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

A performance parameter of a RFID tag is its sensitivity or the minimum power required to be activated and respond. A typical near-field ultra-high frequency (UHF) RFID tag antenna is a single loop structure, whose inductance is matched to the capacitance of the chip at the tag operating frequency. However, as the loop area of the loop antenna increases, the power coupled into the RFID tag from the ambient field is also increased. However, the useful loop area of the loop antenna is limited by the RFID chip capacitance, because the loop antenna inductance of the loop antenna is matched to the RFID chip capacitance. Thus, maximum power coupling and the RFID tag field sensitivity is limited by the RFID chip capacitance.

In this regard, embodiments disclosed in the detailed description include discontinuous loop antennas. Related components, tags, systems, and methods are also disclosed. A discontinuous loop antenna is an antenna loop structure that includes a discontinuity portion. The discontinuous loop antenna can be coupled to an RFID chip to provide an RFID tag as a non-limiting example. The discontinuity portion allows the discontinuous loop antenna to have magnetic field sensitivity at greater than one wavelength of the discontinuous loop antenna. Thus, the discontinuous loop antenna has significantly increased near-field sensitivity over other antennas. The discontinuous loop antenna significantly increases near-field sensitivity. Increased near-field sensitivity provides increased power harvesting efficiency during near-field coupling. As one non-limiting example, an RFID tag having a discontinuous loop antenna may achieve up to one hundred (100) times more power harvesting from a radio-frequency (RF) signal than an RFID having a continuous loop antenna tuned to the same or similar resonant frequency.

In this regard, a discontinuity portion provided in the antenna loop structure introduces a discontinuity capacitor into the antenna loop structure. The introduction of the discontinuity capacitor decreases the inductance in the antenna loop structure. As a result, the inductance of the antenna loop structure can be increased from the decreased inductance provided by the discontinuity portion by increasing the loop area of the antenna loop structure. As a result of this increased loop area, the discontinuous loop antenna provides increased near-field sensitivity for increased power harvesting efficiency during near-field coupling. Providing increased near-field sensitivity for increased power harvesting efficiency during near-field coupling may allow an RFID tag to be unaffected in certain environments or mediums that otherwise may not be possible. Also by increasing the inductance of the discontinuous loop antenna, impedance matching to the RFID chip can be retained, as would have been achieved with a smaller loop area continuous loop antenna structure.

Further, because the capacitance is provided through a discontinuity portion in the loop antenna structure, the discontinuity capacitor can be adjusted to be lowered to tune the resonant frequency of the discontinuous loop antenna. This is achieved from the characteristic that the discontinuity capacitor, by being in series and smaller than the fixed capacitance of a load, dominates and lowers the overall capacitance of the load. Thus, a load having a discontinuous loop antenna can be tuned to match different frequency bands and/or be applied to articles where tuning may be required for performance.

With the use of discontinuous loop antennas as discussed by example herein, the loop area of the antenna loop can be increased in size to increase loop antenna inductance, and thus increase field sensitivity and power coupling, beyond that provided by a continuous loop antenna. As a non-limiting example, an improvement of twenty (20) dB in power coupling may be realized. Further, use of discontinuous loop antennas as discussed by example herein, can improve the loop mode coupling of the loop antenna without having to increase the overall length of the antenna, thus allowing the discontinuous loop antenna to be provided in a smaller form factor over other traditional far-field coupling antennas.

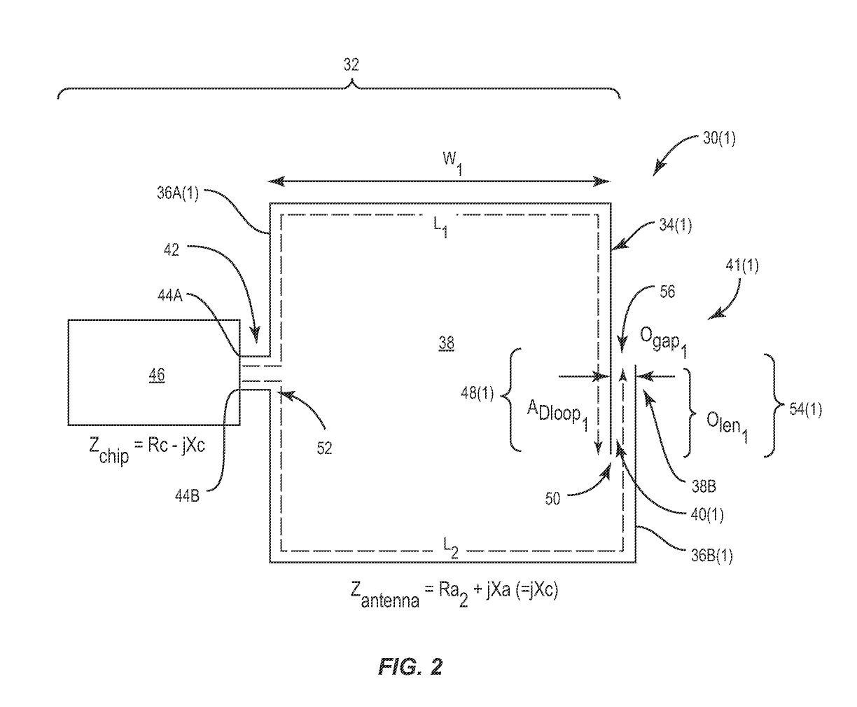

In this regard, FIG. 2 is a diagram of an exemplary discontinuous loop antenna that includes a discontinuity portion in a loop conductor to provide a discontinuity capacitor in the loop conductor. In the example of FIG. 2, the discontinuity portion is formed specifically by an overlap formed in a loop conductor, but note that a discontinuity portion can be provided in other forms, as will be discussed by other examples in this disclosure. As illustrated in FIG. 2, a discontinuous loop antenna 30(1) is provided. The discontinuous loop antenna 30(1) is configured to be electrically coupled to an RFID chip to provide a RFID tag 32, as a non-limiting example. The RFID tag 32 may be a passive RFID tag meaning that energy from the electro-magnetic field of a wireless RF signal is harvested to provide power for operation. The RFID tag 32 may also be an active RFID tag meaning that an energy source, such as a battery, is provided to provide power for operations. The RFID tag 32 may also be a semi-passive RFID tag meaning that an energy source, such as a battery, may be provided to provide power for operation in addition to having the ability to harvest power from a wireless RF signal. The discontinuous loop antennas disclosed herein can be used to significantly increase near-field sensitivity and extend the communications range of passive, semi-passive, and active RFID tags, each of which can be contemplated as the RFID tag 32 in FIG. 2.

With continuing reference to FIG. 2, the discontinuous loop antenna 30(1) includes a loop conductor 34(1). In this embodiment, the loop conductor 34(1) includes a first conductor 36A(1) and a second conductor 36B(1). For example, the first and second conductors 36A(1), 36B(1) may be wires. As another example, the first and second conductors 36A(1), 36B(1) may be conductive traces in a substrate or printed circuit board (PCB) if the RFID tag 32 is mounted to a substrate or PCB, as non-limiting examples. The first conductor 36A(1) and the second conductor 36B(1) are arranged in an enclosed loop formation, as illustrated in FIG. 2, to form a loop conductor area 38 inside the enclosed loop conductor 34(1) having a loop conductor inductance. A discontinuity portion 40(1) is disposed in the loop conductor 34(1) as a function of a discontinuity provided between the first and second conductors 36A(1), 36B(1). The discontinuity portion 40(1) forms a discontinuity capacitor 41(1) in the loop conductor 34(1). As discussed above, introducing the discontinuity capacitor 41(1) in the loop conductor 34(1) decreases the loop conductor 34(1) inductance.

With continuing reference to FIG. 2, the first conductor 36A(1) is provided with a first length L₁ having a first width W₁. The first conductor 36A(1) has a first end 42 configured to be electrically coupled to a first antenna node 44A of a RFID chip 46 for antenna coupling. The first conductor 36A(1) also has a second end portion 48(1) of a second length Oₗₑₙ₁ disposed at a second end 50. The second conductor 36B(1) of the loop conductor 34(1) is also provided. The second conductor 36B(1) also has a first length L₂ and first width W₁. The second conductor 36B(1) has a first end 52 configured to be electrically coupled to a second antenna node 44B of the RFID chip 46 for antenna coupling. The second conductor 36B(1) has a second end portion 54(1) of a second length Oₗₑₙ₁disposed at a second end 56 of the second conductor 36B(1).

The formula for inductance ‘L’ due to the introduction of the discontinuity portion 40(1) to the loop conductor 34(1) of the discontinuous loop antenna 30(1) is shown below, where ‘L_{dis}’ is the inductance correction factor. Due to the introduction of discontinuity portion 40(1), the effective inductance of the loop conductor 34(1) decreases by an amount equal to ‘L_{dis}’, and this correction factor can be reduced to zero by increasing the overlap length Oₗₑₙ₁ of the second end portions 48(1), 54(1) of the first and second conductors 36A(1), 36B(1), respectively. The overlap length Oₗₑₙ₁ for which the inductance of a discontinuous loop antenna 30(1) equals the inductance of an equivalent sized continuous loop antenna is termed ‘O_{lenC}’ in the inductance formula below. Upon increasing the overlap length Oₗₑₙ₁ beyond ‘O_{lenC}’, the inductance of the discontinuous loop antenna 30(1) can be increased over the inductance offered by an equivalent sized continuous loop antenna.

L=2W₁μ₀μᵣ/π [ln(W₁/a)−0.77401]−L_{dis}(Oₗₑₙ₁,O_{gap1}),
where Oₗₑₙ₁<O_{lenC}

L=2W₁μ₀μᵣ/π [ln(W₁/a)−0.77401]+L_{dis}(Oₗₑₙ₁,O_{gap1}),
where Oₗₑₙ₁>O_{lenC}

C_{dis}=C_{dis}(Oₗₑₙ₁,O_{gap1})

Along with the reduction of the loop conductor 34(1) inductance, the discontinuity portion 40(1) in the loop conductor 34(1) produces an inherent capacitance in the antenna, ‘C_{dis}’ which is a function of overlap length Oₗₑₙ₁ and the gap distance O_{gap1} between the second end portions 48(1), 54(1) of the first and second conductors 36A(1), 36B(1). The capacitance of the discontinuous loop antenna 30(1) is found to increase with the overlap length Oₗₑₙ₁ up to a certain value of overlap length Oₗₑₙ₁, and then remain substantially constant. For a fixed overlap length Oₗₑₙ₁, the loop conductor 34(1) capacitance is found to be at a maximum, and the loop conductor 34(1) inductance is found to be at a minimum when the center of the overlapped second end portions 48(1), 54(1) of the first and second conductors 36A(1), 36B(1) is located equidistant from the two antenna nodes 44A, 44B, with the distance measured along the circumference of the loop conductor 34(1).

In this regard, the reduction of loop conductor 34(1) inductance along with the addition of capacitance to the loop conductor 34(1) makes the loop conductor 34(1) more capacitive in nature, which would no longer provide an inductive match to the capacitive RFID chip 46 unless the area A_{Dloop1} of the loop conductor 34(1) is also increased accordingly. The now capacitive loop conductor 34(1) can be turned inductive by increasing the width W₁ of the loop conductor 34(1), or increasing overlapping length Oₗₑₙ₁ of the loop conductor 34(1). Either increases the magnetic field sensitivity of the discontinuous loop antenna 30(1), which in turn provides increased power coupling and communication range during near-field coupling. As examples, increasing the width W₁ of the loop conductor 34(1) may result in large-size (e.g., >10 cm²) discontinuous loop antenna 30(1). Increasing Oₗₑₙ₁ may result in medium (e.g., 4-10 cm²) or small-sized (e.g., ˜1 to 4 cm²) discontinuous loop antenna 30(1).

The gap distance O_{gap1} does slightly affect the loop conductor 34(1) inductance of the discontinuous loop antenna 30(1). However the O_{gap1} parameter is not as prominent in determining loop conductor 34(1) inductance as Oₗₑₙ₁ due to the capability to change Oₗₑₙ₁, even after fabrication for tuning purposes, and also the magnetic field sensitivity of the loop conductor 34(1) being less impacted at larger O_{gap1} gap distances. Thus, two important terms that impact the capacitive reactance and the inductive reactance of the discontinuous loop antenna 30(1) in FIG. 2 are the width W₁ and Oₗₑₙ₁.

In summary of FIG. 2, the discontinuity portion 40(1) provided in the loop conductor 34(1) introduces a discontinuity capacitor 41(1) into the loop conductor 34(1). The introduction of the discontinuity capacitor 41(1) decreases the inductance in the loop conductor 34(1). The resulting change in impedance of increasing capacitance and reducing inductance of the discontinuous loop antenna 30(1) by introduction of the discontinuity portion 40(1) in the loop conductor 34(1) can be utilized in several manners to provide increased near-field sensitivity while maintaining impedance matching to the RFID chip 46 in the RFID tag 32. Increasing near-field sensitivity for the RFID tag 32 provides increased power harvesting during near-field coupling.

In one non-limiting example with reference to FIG. 2, the inductance of the discontinuous loop antenna 30(1) can be increased from the decreased inductance provided by the discontinuity portion 40(1) by increasing the loop area A_{Dloop1} of the loop conductor 34(1). As a result of this increased loop area, the discontinuous loop antenna 30(1) provides higher magnetic field sensitivity for increased power harvesting during near-field coupling. Also by increasing the inductance of the discontinuous loop antenna 30(1), impedance matching to the RFID chip 46 can be retained, as would have been achieved with a smaller loop area continuous loop antenna structure.

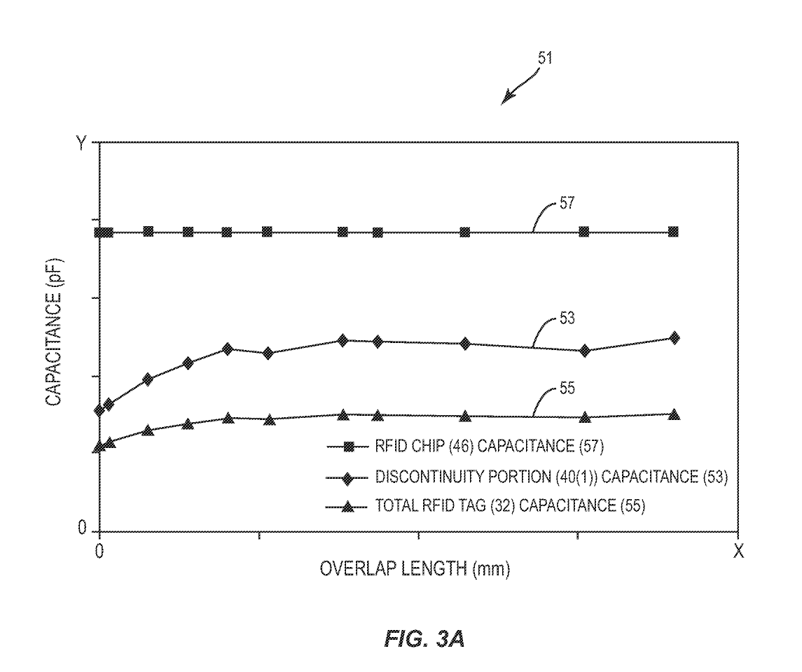

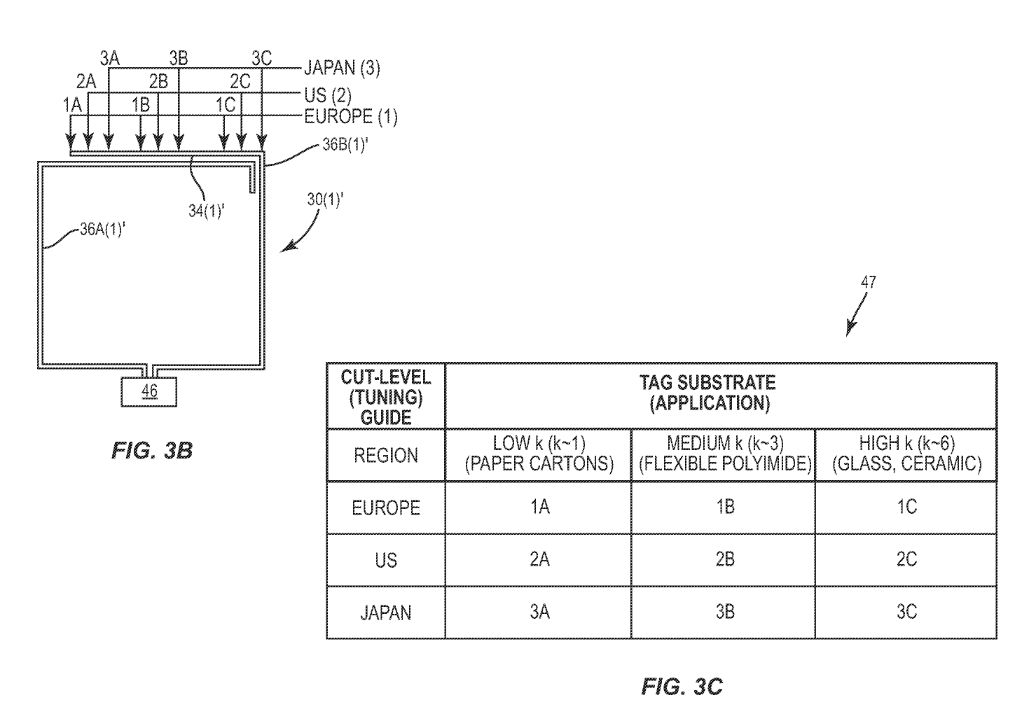

Further, because the capacitance of the loop conductor antenna 30(1) in FIG. 2 is provided in the loop conductor 34(1) through the discontinuity portion 40(1) in the loop conductor 34(1), the capacitance of the discontinuity capacitor 41(1) can be adjusted. For example, referring to the exemplary capacitance plot 51 in FIG. 3A, the discontinuity capacitance 53 of the discontinuity capacitor 41(1) can be lowered by reducing the length Oₗₑₙ₁ of overlap of the loop conductors 36A(1), 36B(1) (shown in FIG. 2). Lowering the discontinuity capacitance 53 of the discontinuity capacitor 41(1) lowers the overall RFID tag capacitance 55 of the RFID tag 32 employing the discontinuous loop antenna 30(1), because the discontinuity capacitor 41(1) in series and smaller than the RFID chip capacitance 57 of the RFID chip 46 coupled to the discontinuous loop antenna 30(1). Thus, the discontinuity capacitance 53 of the discontinuity capacitor 41(1) dominates and lowers the total RFID tag capacitance 55. This allows the RFID tag 32 employing the discontinuous loop antenna 30(1) to be tuned to a desired resonant frequency to be matched to different frequency bands and/or be applied to articles where tuning may be required for performance.

A discontinuous loop antenna will be highly sensitive to H-fields with little E-field sensitivity reduction. This is illustrated by example in Table 1 below, which illustrates advantages of the discontinuous loop antennas, including those described herein.

TABLE 1
Coupling responses to E-fields and H-fields for exemplary
dipole, loop, and discontinuous loop antenna

| | Response to E-Field | | Response to H-Field | |
|---|---|---|---|---|
| | (10 V/m) | | (−10 dBA/m) | |
| ½ Wave Wire Dipole | 1.85 mW | (Ref) | Too small to measure | |
| (Far Field Antenna) | | | | |
| Loop Antenna | negligible | | 1.96 mW | (Ref) |
| (Near Field Antenna) | | | | |
| 915 MHz Discontin- | 0.823 mW | (−3.5 dB) | 117 mW | (+17.7 dB) |
| uous Loop Antenna | | | | |
| (6.9 cm × 3 cm) | | | | |
| (near-field Antenna) | | | | |

In the discontinuous loop antenna 30(1) of FIG. 2, the discontinuity portion 40(1) is formed by a single discontinuity in the loop conductor 34(1). Providing a single discontinuity may be advantageous, because with two or more discontinuities, at least one conductor in the discontinuous loop antenna would be isolated. Providing an isolated conductor may reduce or eliminate the inductance of the discontinuous loop antenna, and provide a capacitive discontinuous loop antenna, which would not allow for impedance matching to a capacitive load, such as an RFID chip.

Based on the antenna classification desired, a discontinuous loop antenna, including the discontinuous loop antenna 30(1), can be designed to be Low Frequency (LF) antennas (e.g., <125 KHz), Medium Frequency (MF) antennas (e.g., 3 MHz to 30 MHz), Ultra-high Frequency (UHF) antennas (e.g., 433 MHz to 960 MHz), or Super High Frequency (SHF) (e.g., 3 GHz to 30 GHz) antenna. Embodiments of the discontinuous loop antennas disclosed below in the remainder of this disclosure relate to UHF RFID tag antennas and European (i.e., 865 to 868 MHz), United States (i.e., 902 to 928 MHz) and Japanese (i.e., 954 to 957 MHz) RFID bands. The frequency of the received RF signal determines the effective size of the discontinuous loop antennas. Smaller discontinuous loop antennas have less radiation coupling capability, and thus it may be desirable to maximize the size of the discontinuous loop antennas in order to achieve maximum radiation coupling and a resulting increase in power-harvesting performance.

In this regard, FIG. 3B is an exemplary discontinuous loop antenna 30(1)′ similar to the discontinuous loop antenna 30(1) in FIG. 2. The discontinuous loop antenna 30(1)′ in FIG. 3B has markers (shown as 1A, 1B, 1C, 2A, 2B, 2C, 3A, 3B, and 3C) disposed in the loop conductor 34(1)′ that provide trimming points where a second conductor 36B(1)′ of the loop conductor 34(1)′ can be trimmed to tune the resonant frequency of the discontinuous loop antenna 30(1)′. For example, the markers may be indicated by markings, which may be color coded, if desired. As discussed above, by adjusting the length of the overlap of the first and second conductors 36A(1)′, 36B(1)′, the discontinuity capacitance can be adjusted, thereby adjusting the total capacitance of an RFID tag employing the discontinuous loop antenna 30(1)′. By reducing the length of the overlap of the first and second conductors 36A(1)′, 36B(1)′, the discontinuity capacitance can be reduced, thereby reducing the total capacitance of an RFID tag employing discontinuous loop antenna 30(1)′.

Thus, the discontinuous loop antenna 30(1)′ can be adjusted to operate at RFID frequency bands being different for different regions (US, Europe and Japan) of the world, one antenna optimized for very good performance for one region would not perform to the same degree in another region. In this regard, FIG. 3C is an exemplary data sheet 47 that can be used by a technician to tune the discontinuous loop antenna 30(1)′ in FIG. 3B. The data sheet 47 indicates which markers correspond to different regions having different RFID operating frequencies and further based on the medium in which the discontinuous loop antenna 30(1)′ will be employed. The user can cut-back (or tune) the second conductor 36B(1)′ by simply using a pair of scissors or other cutting device. Alternately, this technique lends itself to easy automation at the time of manufacturing without the need to create multiple antenna designs. A single substrate can be manufactured and stocked and then an automated trim process can tailor a discontinuous loop antenna for the point of intended use.

Further, because discontinuous loop antennas are very sensitive to magnetic fields, discontinuous loop antennas can perform when deployed in environments that may otherwise impede the performance of RFID tags employing continuous loop antennas. A discontinuous loop antenna can provide an end user or technician the feasibility to tailor the antenna characteristics for better performance based on the actual application environment. A discontinuous loop antenna can allow easy tuning of tags and overcome harsh RF environments such as presence as disposition of the RFID tag on a high dielectric material, such as glass, or in close proximity to an absorbing material such as water. Water attenuates E-field propagation, but H-fields are impervious to a liquid, such as water, thus allowing a discontinuous loop antenna to perform in water or other liquid. For example, a discontinuous loop antenna could have about 7 dB higher sensitivity than very sensitive far-field antennas when surrounded, placed on water bodies such as a bottle of water or other commercial drink container, or placed within a RFID tag communication range of a liquid.

In this regard, an experimental test set-up was performed for a discontinuous loop antenna of 4.8 cm×4.3 cm as compared with a very sensitive and broadband UHF far-field monopole antenna 12 cm long. In the experiment the antennas were placed in an air-tight glass bottle. The air-tight glass bottle was placed in a jar filled with water. The antennas were compared against power-margin, a performance metric in dB which is equal to the RFID reader power required to read a RFID tag (in dB) employing the antennas subtracted from a predefined or set maximum RFID reader power (e.g., 30 dBm). As shown in Table 2 below, it was observed under these simulated harsh conditions, the power margin can deteriorate as high as 19 dB from free-space performance for the monopole antenna at a distance of 20 inches from an RFID reader antenna. However, the power margin deterioration for the discontinuous loop antenna was 10 dB lower at that same distance. The discontinuous loop antenna was observed to perform with at least 6 dB higher power coupling than the far-field monopole antenna even at a distance of 1 m from the 2 dBi RFID reader antenna fed with 1 W power.

TABLE 2
Power margin of discontinuous loop antenna over monopole
antenna as function of medium and distance

| Distance (in) | 5″ | 10″ | 20″ | 40″ |
|---|---|---|---|---|
| PM in Air (dB) | 29 | 25 | 23 | 20 |
| (Monopole) | | | | |
| PM in Water (dB) | 10 | 7 | 4 | 6 |
| (Monopole) | | | | |
| PM loss (dB) due to | 19 | 18 | 19 | 14 |
| Water (Monopole) | | | | |
| PM in Air (dB) | 29 | 23 | 23 | 20 |
| (Discontinuous Loop) | | | | |
| PM in Water (dB) | 17 | 16 | 14 | 12 |
| (Discontinuous Loop) | | | | |
| PM loss (dB) due to | 12 | 7 | 9 | 8 |
| Water (Discontinuous | | | | |
| Loop) | | | | |

The remainder of this disclosure will discuss methods, techniques and examples of altering discontinuous loop antenna inductance and/or capacitance to provide the desired coupling performance. One way to increase loop conductor inductance of a discontinuous loop antenna is to increase the loop area enclosed by the loop conductor. An alternate method to increase the loop conductor inductance of a discontinuous loop antenna is to increase the overlap of overlapping conductor portions that form the discontinuity portion and discontinuity capacitor in the loop conductor. These methods can be realized by increasing the length of the overlapping conductor portions along the contour of the loop conductor, to surround or partially encircle the remainder of the loop conductor. These methods make it more feasible to change the loop conductor inductance (and correspondingly the center frequency) of the discontinuous loop antenna even after the fabrication of the discontinuous loop antenna structure is complete, and thus to tune the antenna resonant frequency dependent on the application environment.

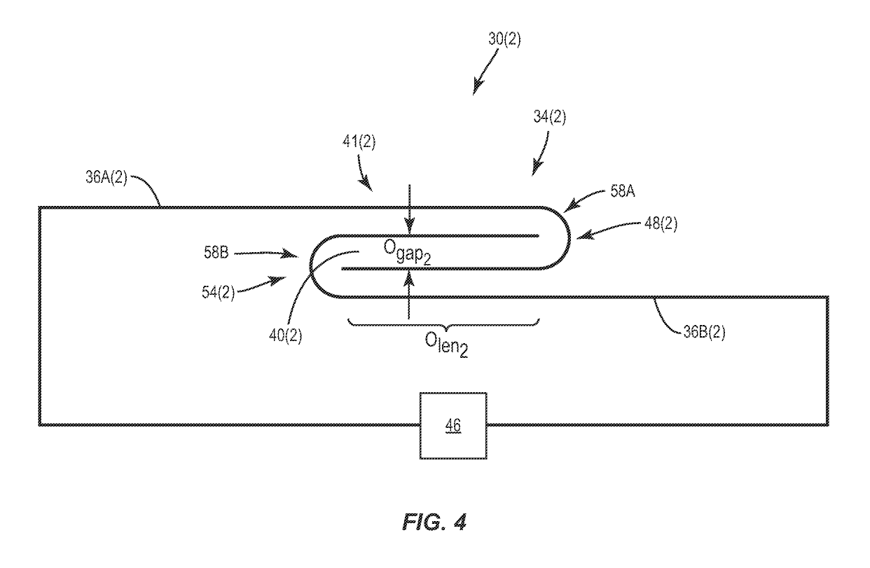

A discontinuity portion can be provided in a loop conductor in other forms to provide a discontinuity loop antenna. In this regard, FIG. 4 is a diagram of another exemplary discontinuous loop antenna having a discontinuity portion formed by an overlap provided in the loop conductor. As illustrated in FIG. 4, another example of discontinuous loop antenna 30(2) provided by overlapping conductors is provided. The discontinuous loop antenna 30(2) is also configured to be electrically coupled to an RFID chip, such as RFID chip 46, to provide a RFID tag. The discontinuous loop antenna 30(2) includes a loop conductor 34(2). In this embodiment, the loop conductor 34(2) includes a first conductor 36A(2) and a second conductor 36B(2) each having end portions 48(2), 54(2), respectively, that overlap each other at an overlap distance Oₗₑₙ₂ at a gap distance O_{gap2} to form a discontinuity portion 40(2). The first conductor 36A(2) and the second conductor 36B(2) include approximate one hundred eight (180) degree turns 58A, 58B, respectively, to provide the discontinuity portion 40(2) in the loop conductor 34(2). The discontinuity portion 40(2) forms a discontinuity capacitor 41(2) in the loop conductor 34(2) to introduce a discontinuity capacitor 41(2) in the loop conductor 34(2). As discussed above, introducing the discontinuity capacitor 41(2) in the loop conductor 34(2) decreases the loop conductor 34(2) inductance.

The reduction of loop conductor 34(2) inductance along with the addition of discontinuity capacitor 41(2) to the loop conductor 34(2) makes the loop conductor 34(2) more capacitive in nature, which would no longer provide an inductive match to a capacitive RFID chip unless the inductance of the loop conductor 34(2) is also increased accordingly. Increasing the inductance of the loop conductor 34(2) increases the magnetic field sensitivity of the discontinuous loop antenna 30(2), which in turn provides increased power coupling and communication range during near-field coupling.

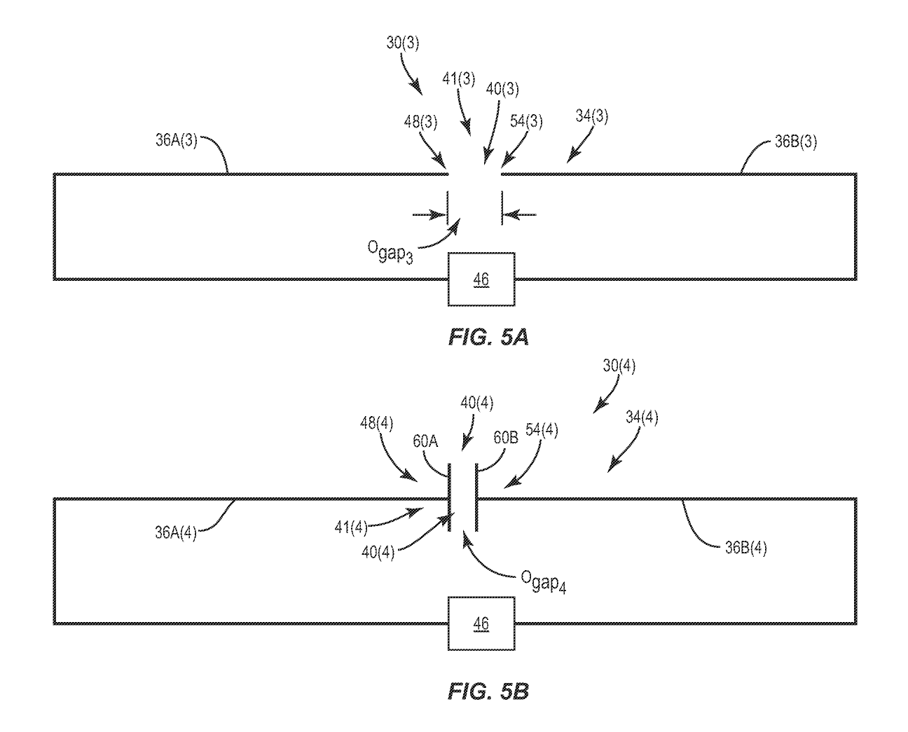

As discussed above, a discontinuity portion may be provided in a loop conductor to form a discontinuous loop antenna in other manners other than providing an overlap in a loop conductor. For example, FIGS. 5A and 5B are diagrams of other exemplary discontinuous loop antennas having a discontinuity portion formed by an end gap provided in a loop conductor. As illustrated in FIG. 5A, a discontinuous loop antenna 30(3) is provided that includes a loop conductor 34(3). In this embodiment, the loop conductor 34(3) includes a first conductor 36A(3) and a second conductor 36B(3) each having end portions 48(3), 54(3) that do not overlap, but are disposed at a gap distance O_{gap3} from each other to form a discontinuity portion 40(3). The discontinuity portion 40(3) forms a discontinuity capacitor 41(3) in the loop conductor 34(3) to introduce a discontinuity capacitor 41(3) in the loop conductor 34(3). As discussed above, introducing the discontinuity capacitor 41(3) in the loop conductor 34(3) decreases the loop conductor 34(3) inductance to allow for the inductance to then be increased to provide increased magnetic field sensitivity and power harvesting.

As illustrated in FIG. 5B, an alternative discontinuous loop antenna 30(4) is provided that includes a loop conductor 34(4). In this embodiment, the loop conductor 34(4) includes a first conductor 36A(4) and a second conductor 36B(4) each having end portions 48(4), 54(4) that do not overlap, but are disposed at a gap distance O_{gap4} from each other to form a discontinuity portion 40(4). The end portions 48(4), 54(4) in this embodiment contain planar portions 60A, 60B disposed orthogonal to the longitudinal axis of the loop conductors 36A(4), 36B(4). The discontinuity portion 40(4) forms a discontinuity capacitor 41(4) in the loop conductor 34(4) to introduce a discontinuity capacitor 41(4) in the loop conductor 34(4). As discussed above, introducing the discontinuity capacitor 41(4) in the loop conductor 34(4) decreases the loop conductor 34(4) inductance to allow for the inductance to then be increased to provide increased magnetic field sensitivity and power harvesting.

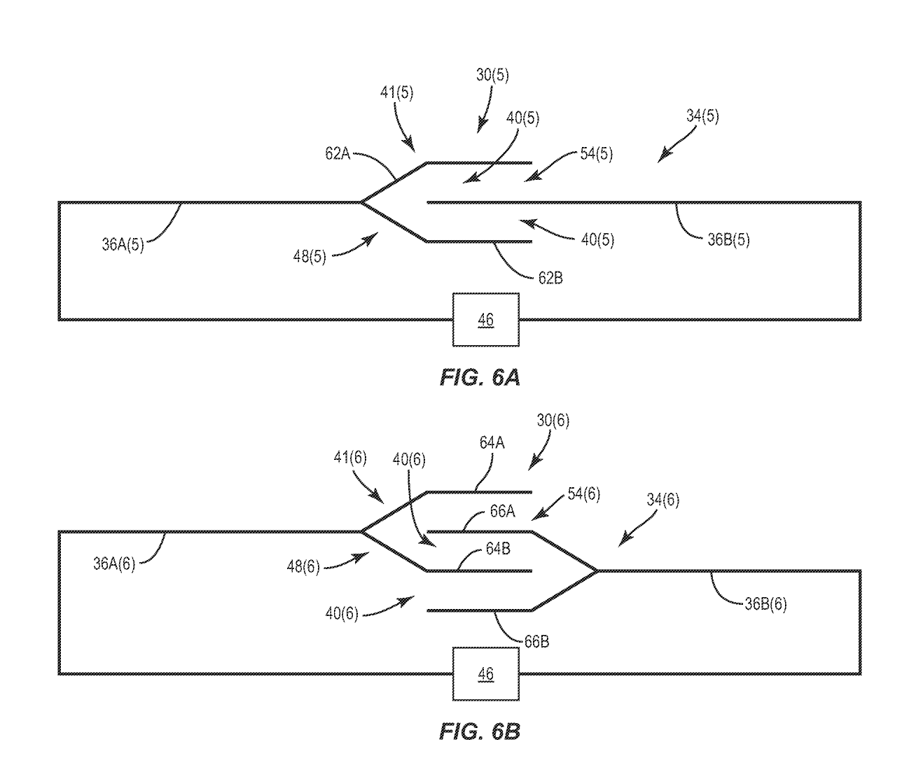

FIGS. 6A and 6B are diagrams of other exemplary discontinuous loop antennas having discontinuity portions formed by inter-digitated portions provided in a loop conductor as other examples of discontinuous loop antennas. As illustrated in FIG. 6A, an alternative discontinuous loop antenna 30(5) is provided that includes a loop conductor 34(5). In this embodiment, the loop conductor 34(5) includes a first conductor 36A(5) and a second conductor 36B(5) each having end portions 48(5), 54(5) that overlap to form a discontinuity portion 40(5). The end portion 54(5) is disposed between two branch portions 62A, 62B of the end portion 48(5). The discontinuity portion 40(5) forms a discontinuity capacitor 41(5) in the loop conductor 34(5) to introduce a discontinuity capacitor 41(5) in the loop conductor 34(5). As discussed above, introducing the discontinuity capacitor 41(5) in the loop conductor 34(5) decreases the loop conductor 34(5) inductance to allow for the inductance to then be increased to provide increased magnetic field sensitivity and power harvesting.

FIG. 6B, an alternative discontinuous loop antenna 30(6) is provided that includes a loop conductor 34(6). In this embodiment, the loop conductor 34(6) includes a first conductor 36A(6) and a second conductor 36B(6) each having end portions 48(6), 54(6) that overlap to form a discontinuity portion 40(6). The end portion 48(6) has the two branch portions 64A, 64B, and the end portion 54(6) has two branch portions 66A, 66B. Branch portion 66A is disposed between branch portions 64A, 64B, and branch portion 64B is disposed between branch portions 66A, 66B. The discontinuity portion 40(6) forms a discontinuity capacitor 41(6) in the loop conductor 34(6) to introduce a discontinuity capacitor 41(6) in the loop conductor 34(6). As discussed above, introducing the discontinuity capacitor 41(6) in the loop conductor 34(6) decreases the loop conductor 34(6) inductance to allow for the inductance to then be increased to provide increased magnetic field sensitivity and power harvesting.

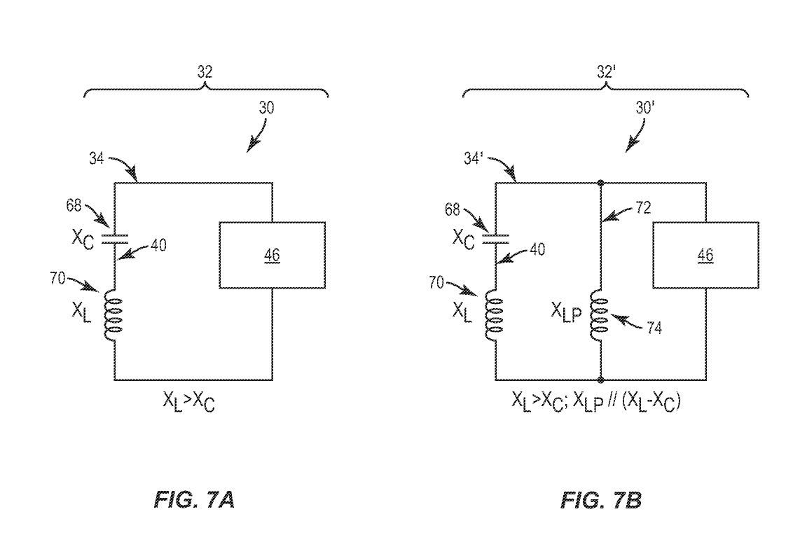

FIGS. 7A and 7B are equivalent circuit diagrams of exemplary representations of a generic discontinuous loop antenna 30 coupled to the RFID chip 46 without and with an electrostatic discharge (ESD) shunt, respectively. For example, the discontinuous loop antenna 30 could be any of the discontinuous loop antennas 30(1)-30(6) described above. The discontinuous loop antenna 30 in FIG. 7A has an inductance 68 and a capacitance 70 in series forming the loop conductor 34 and does not include an ESD shunt. The inductive impedance (X_{L}) of the discontinuous loop antenna 30 is matched to the overall series capacitive impedance of the RFID chip 46 and discontinuous loop antenna 30 combined (X_{Cchip}+X_{C}). In the discontinuous loop antenna 30′ in FIG. 7B, an ESD shunt 72 is included that includes an extra inductive element 74 that is disposed in parallel to a loop conductor 34′ and the RFID chip 46 to provide inductive impedance (X_{LP}) that can be tuned by varying the closed loop area enclosed by the ESD shunt 72 in parallel with the RFID chip 46. The ESD shunt 72 is not necessary for discontinuous loop antenna 30′ performance. The introduction of the ESD shunt 72 in the loop conductor 34′ has an effect on the impedance of the discontinuous loop antenna 30′ that can be nullified. However, when an ESD event occurs, the ESD shunt 72 acts as a direct current (DC) shunt providing extra ESD protection to the RFID chip 46. The position or the layout of the ESD shunt 72 can either be inside or outside of the loop conductor 34′ based on feasibility.

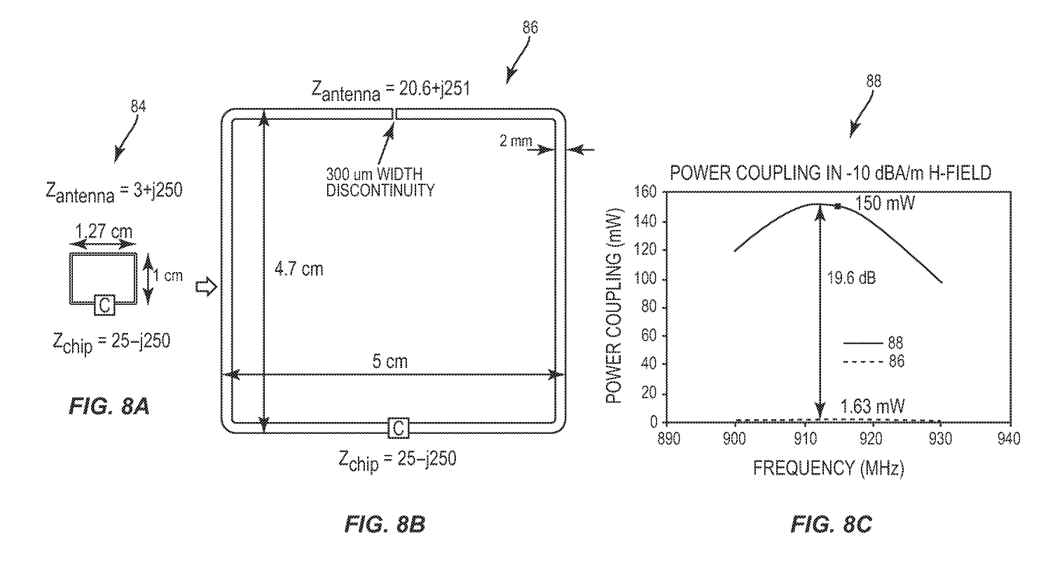

FIGS. 8A and 8B are diagrams of an exemplary continuous loop antenna 84 and exemplary discontinuous loop antenna 86. FIG. 8C is a plot graph 88 comparing the simulated power couplings of the continuous loop antenna 84 and the discontinuous loop antenna 86 in FIGS. 8A and 8B, respectively, in a magnetic field. It is noted from the plot graph 88 in FIG. 8C that the discontinuous loop antenna 86 provided a 150 mW peak power coupling in a H-field, as opposed to a 1.63 mW peak power coupling in the same H-field (i.e., a 19.6 dB difference) by the continuous loop antenna 84 in this example. As seen in FIG. 8C, the power coupling improvement in the discontinuous loop antenna 86 over the continuous loop antenna 84 in −10 dBA/m H-Field (or 0.32 A/m) is about 20 dB. While most of the power coupling advantage is due to the larger loop area enclosed by the discontinuous loop antenna 86, the discontinuous loop antenna 86 can include other intrinsic factors that increase power coupling. It should be noted that both the smaller-sized continuous loop antenna 84 and the larger-sized discontinuous loop antenna 86 were connected across the same RFID chip, or the same chip impedance of 25-j250. The simulation models in FIGS. 8A and 8B were based on placement of an RFID chip and the discontinuous loop antenna 86 on a 100 μm thick polyimide substrate material with a dielectric constant of 3.55.

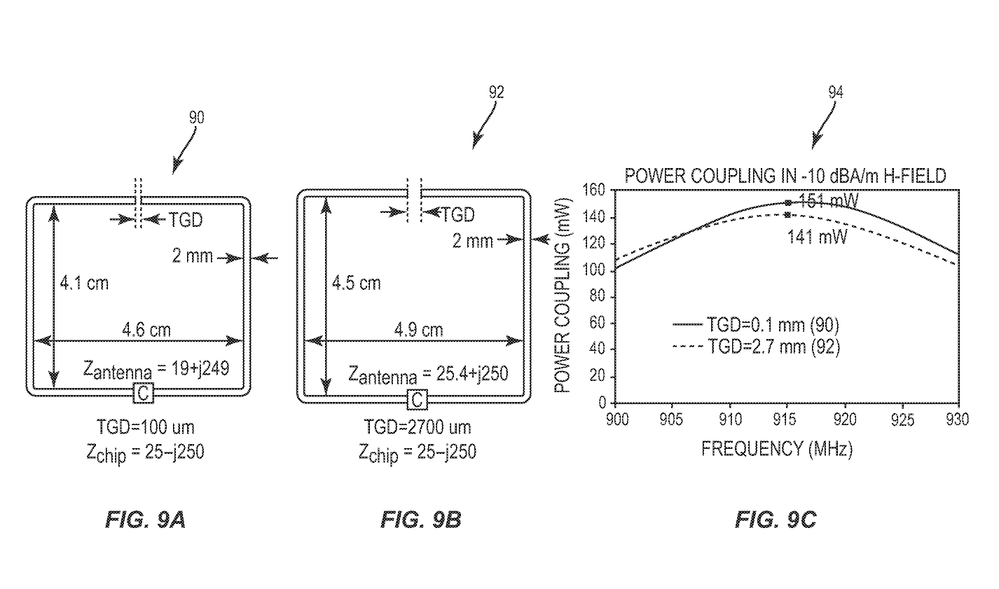

With reference back to the discontinuous loop antenna 30(1) in FIG. 2, large area discontinuous loop antennas are realized by keeping Oₗₑₙ₁ to a minimum and increasing W₁ of the loop conductor 34(1). Maximum area discontinuous loop antennas for a fixed trace width (TW) and trace-to-trace gap (i.e., conductor-to-conductor overlap) at discontinuity (TGD) can be realized by keeping Oₗₑₙ₁ to zero, designing for no conductor overlap, or designing with the conductor discontinuity aligned and separated by a small gap distance O_{gap1}. In this regard, FIGS. 9A and 9B are diagrams of other exemplary discontinuous loop antennas 90, 92 having varied discontinuity gaps. FIG. 9C is an exemplary plot graph 94 comparing the power couplings of the discontinuous loop antennas 90, 92 in FIGS. 9A and 9B, respectively, in the same H-field for a smaller trace-to-trace gap at discontinuity (TGD) in the discontinuous loop antenna 90 in FIG. 9A than a larger TGD in the discontinuous loop antenna 92 in FIG. 9B. The power coupling advantage for a 0.1 mm TGD discontinuous loop over a 2.7 mm TGD is found to be 0.3 dB.

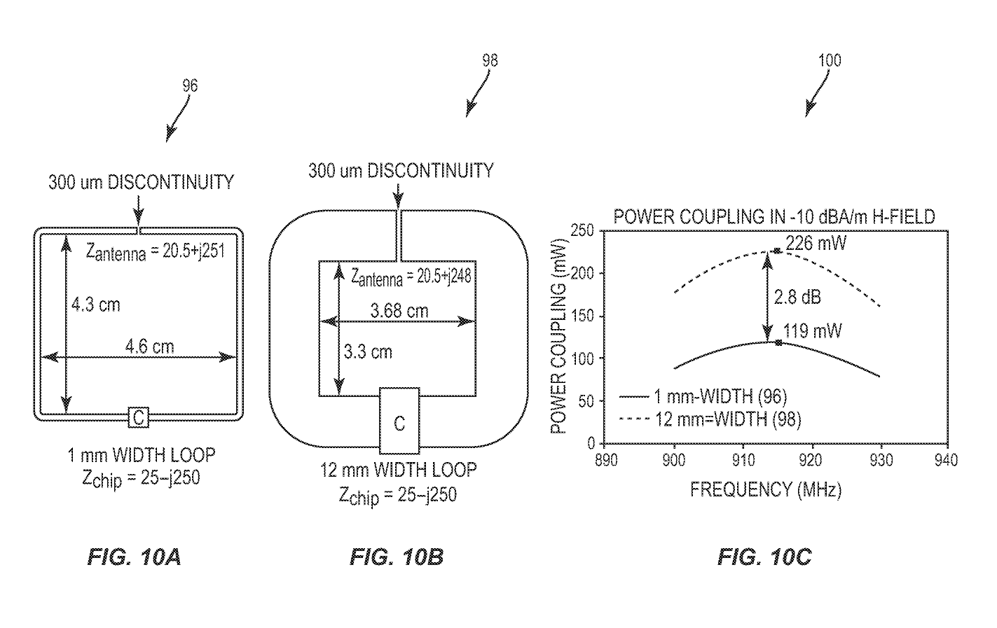

FIGS. 10A and 10B are diagrams of other exemplary discontinuous loop antennas 96, 98, respectively, having varied antenna loop trace widths. The large-size discontinuous loop antennas 96, 98 can be designed with different trace widths. The larger the width of the trace, the greater the power coupling. For an increase of trace width from 1 mm to 12 mm as an example, the power coupling advantage is found to be 2.8 dB. While the no-metal loop area enclosed by the 1 mm width trace discontinuous loop antenna 96 in FIG. 10A for tag impedance match is about 20 sq cm, the no-metal loop area enclosed by the 12 mm width trace discontinuous loop antenna 98 in FIG. 10B for tag impedance match is found to be about 12 cm². The power coupling advantage is primarily attributed to the larger trace width at discontinuity (TWD) for the 12 mm width trace in the discontinuous loop antenna 98 in FIG. 10B than the 1 mm width trace in the discontinuous loop antenna 96. FIG. 10C is an exemplary plot graph comparing the power couplings of the discontinuous loop antennas in FIGS. 10A and 10B, respectively, in a magnetic field.

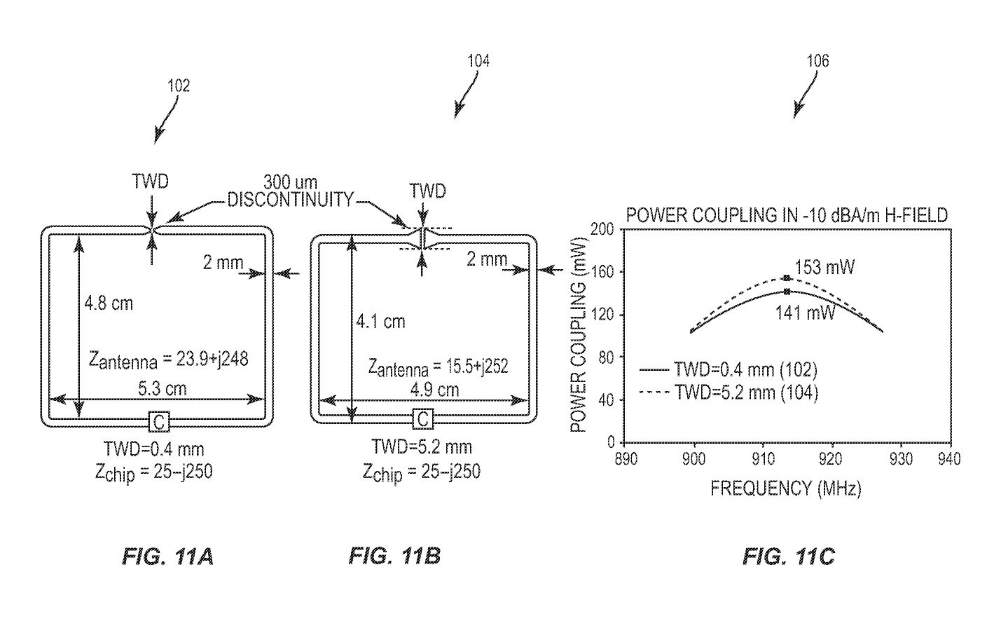

FIGS. 11A and 11B are diagrams of other exemplary discontinuous loop antennas 102, 104 having varied antenna loop trace widths at the discontinuity portion. FIG. 11C is an exemplary plot graph 106 comparing the power couplings of the discontinuous loop antennas in FIGS. 11A and 11B, respectively, in a magnetic field. The effect of the trace width at discontinuity (TWD) on the power coupling of the discontinuous loop antenna 102, 104 is shown. The larger the TWD for a specific loop conductor, the greater the antenna inductance, requiring the loop dimensions to be decreased for tag impedance match. However, the power coupling of the smaller area discontinuous loop antenna 104 can be higher than the larger area enclosing discontinuous loop antenna 102. In the figure the power coupling of 25 sq cm loop, with TWD of 0.4 mm is found to be 141 mW compared to 153 mW for the 20 sq cm loop of TWD=5.2 mm, a coupling advantage of about 0.3 dB. The higher power coupling for higher TWD is attributed to the lower antenna resistance, which introduces less loss in the antenna structure, as could be inferred from the impedances of the two antennas shown in FIG. 11. Keeping the TWD larger than the trace width (TW) can be beneficial in two ways. While keeping the TWD larger than TW helps improve power coupling, it also allows for tuning of maximum area discontinuous loop antennas which have no trace overlap tuning feature, by trimming down the width of the TWD towards TW.

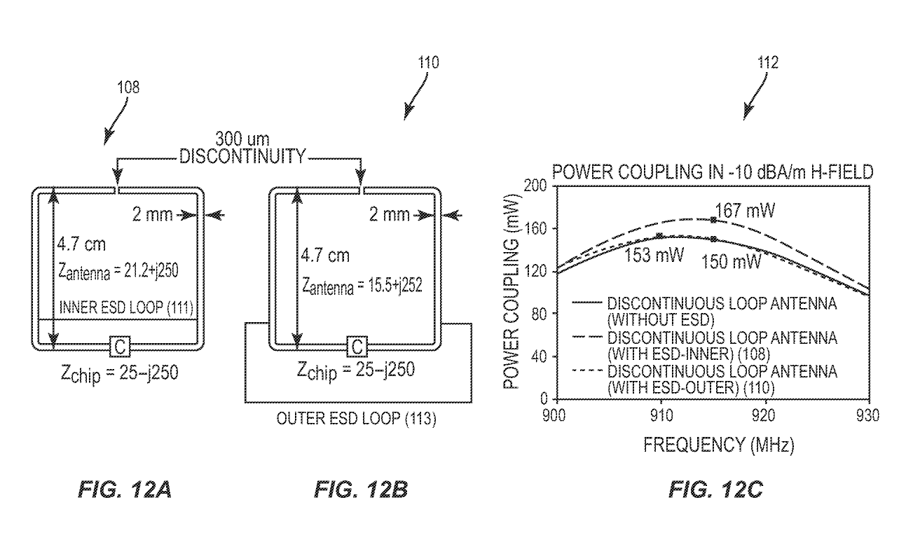

FIGS. 12A and 12B are diagrams of other exemplary discontinuous loop antennas 108, 110 having inner and outer electrostatic discharge (ESD) loops 111, 113, respectively. FIG. 12C is an exemplary plot graph 112 comparing the power couplings of the discontinuous loop antennas 108, 110 in FIGS. 12A and 12B, respectively, in a magnetic field relative to the same discontinuous loop antenna without an ESD trace. The two ESD trace ends in the discontinuous loop antennas 108, 110 connect to either of the two RFID chip terminals, in the form of a shunt element across the capacitive RFID chip. The incorporation of ESD trace is primarily for ESD protection purpose and not for impedance matching, although changing the position of the ESD trace would affect the reactance of the loop. The position of the ESD trace is optimized to create minimal impact on the RF impedance of the discontinuous loop antennas 108, 110. In DC conditions, or in the event of an ESD, the ESD shunt trace acts like a short to ground to the high voltage. Based on the application requirement, the ESD trace can be placed either inside the area of the discontinuous loop antenna 108, or outside the maximum area of the discontinuous loop antenna 110. Along with ESD protection feature, an improvement in power coupling by about 0.5 dB is realized over a discontinuous loop antenna with no ESD. This is attributed to the strengthening of H-field power coupling due to a “loop in a loop” design of the inner ESD loop conductor of the discontinuous loop antenna 108 compared to an outer ESD loop conductor of the discontinuous loop antenna 110, or a loop conductor with no ESD.

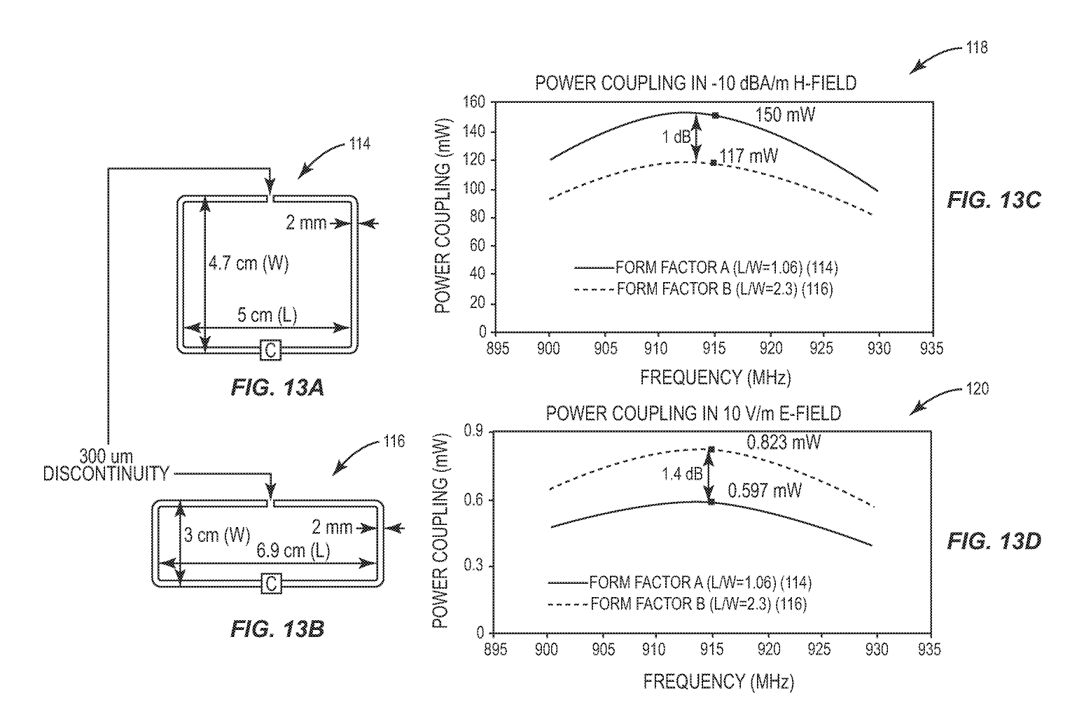

FIGS. 13A and 13B are diagrams of other exemplary discontinuous loop antennas 114, 116 having varied form factors. FIG. 13C is an exemplary plot graph 118 comparing the power couplings of the discontinuous loop antennas 114, 116 in FIGS. 13A and 13B, respectively, in a magnetic field. FIG. 13D is an exemplary plot graph 120 comparing the power couplings of the discontinuous loop antennas 114, 116 in FIGS. 13A and 13B, respectively, in an electric field. The form-factor affects the maximum area of the discontinuous loop antenna 114 for power coupling in E-field and H-field excitation. The E-field sensitivity of the maximum area discontinuous loop antenna 114 can be increased at the expense of its H-field sensitivity by increasing its length to width ratio. With a higher L/W ratio (2.3), the E-field sensitivity of a 6.9 cm long discontinuous loop antenna 116 is 1.4 dB higher than a lower L/W ratio (1.06) discontinuous loop antenna. As illustrated in FIG. 13D, to attain a 1.4 dB higher E-Field sensitivity, 1.0 dB H-field sensitivity is sacrificed. Thus, a simple antenna design variation can be used to tailor the relative H and E-field sensitivity of the discontinuous loop antenna 114, 116.

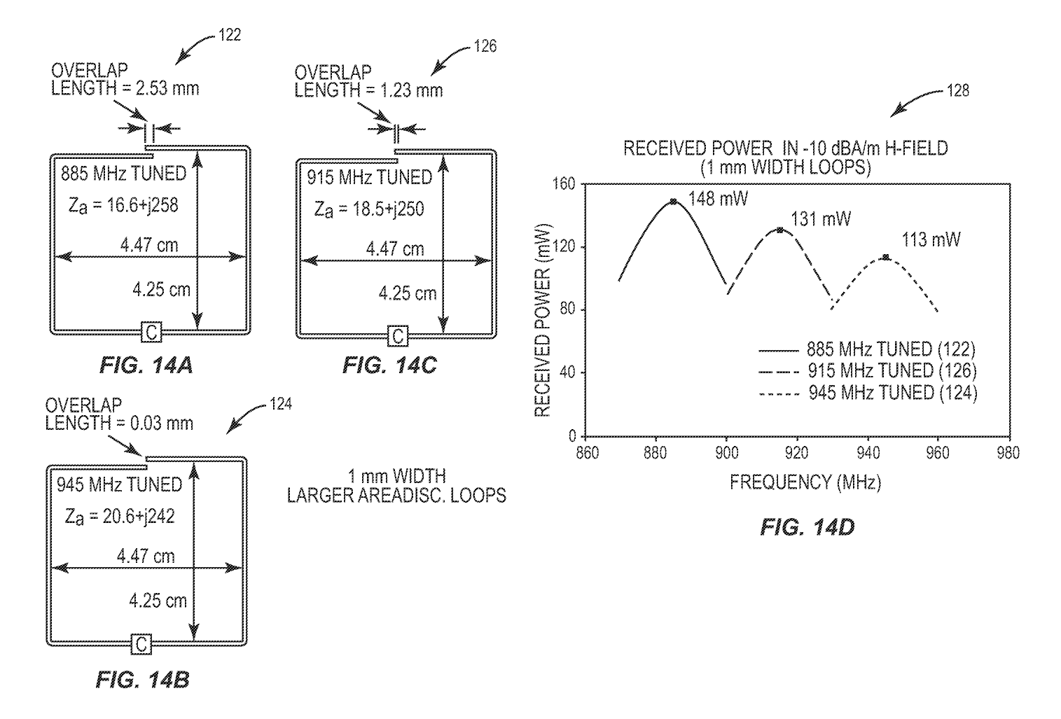

In order to possess the tuning advantage via trace overlap cut-back, it is possible to design large area discontinuous loop antennas instead of maximum area discontinuous loop antennas by keeping a small trace overlap. In this regard, FIGS. 14A-14C are diagrams of other exemplary discontinuous loop antennas 122, 124, 126, respectively, having the same form factor antenna loop size tuned for different center frequencies. FIG. 14D is an exemplary plot graph 128 comparing the power couplings of the discontinuous loop antennas in FIGS. 14A-14C, respectively, as a function of frequency. In FIG. 14A, a trace overlap of 2.53 mm is provided to make the discontinuous loop antenna 122 resonate at 885 MHz. By cutting the trace by approximately 1 mm, the discontinuous loop antenna 126 in FIG. 14C can be designed to resonate at 915 MHz. By cutting the trace further by approximately 1 mm, the discontinuous loop antenna 124 in FIG. 14B can be made to resonate at 945 MHz. In order to change the discontinuous loop antenna resonance to a European band around 866 Mhz, or to a Japanese band at 956 MHz, the cut-back points can extend by 1.5 mm on either side of the cut-back point corresponding to 915 MHz. The cut-back point variation would be larger for smaller size discontinuous loop antenna. The power coupling advantage enjoyed by these large area discontinuous loop antennas 122, 124, 126 could be as high as 19 dB over the small size continuous loop antenna, in this example.

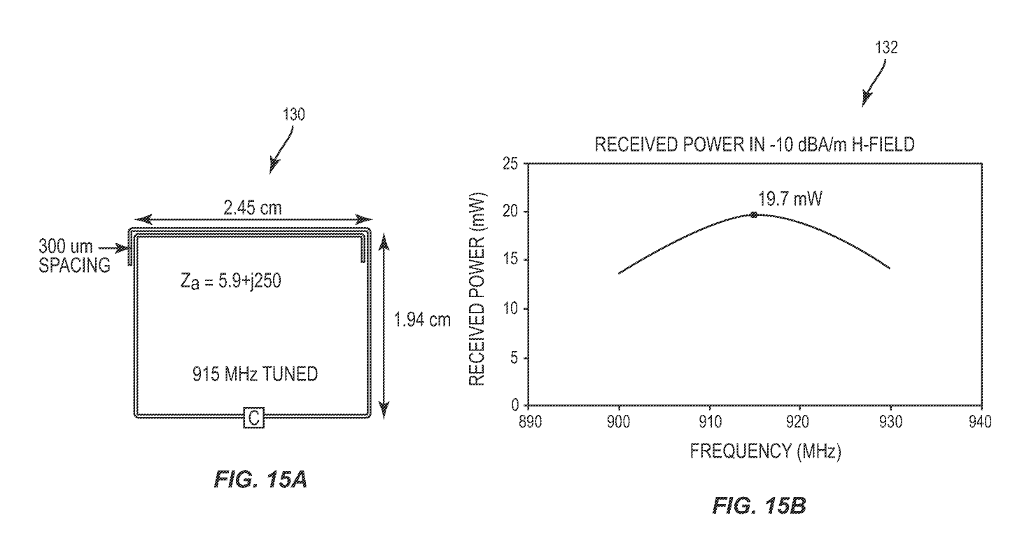

In order to ease the fine cut-back procedure for tuning purpose and facilitate smaller size antennas, the Oₗₑₙ₁ (FIG. 2) design parameter of the discontinuous loop antenna could be increased to realize medium sized (e.g., 4 to 10 sq cm) antennas. In this regard, FIG. 15A is a diagram of another exemplary discontinuous loop antenna 130 sized for space constrained applications realized by overlapping discontinuous loop traces and increasing trace lengths. FIG. 15B is an exemplary plot graph 132 illustrating the power coupling of the discontinuous loop antenna 130 in FIG. 15A in a magnetic field.

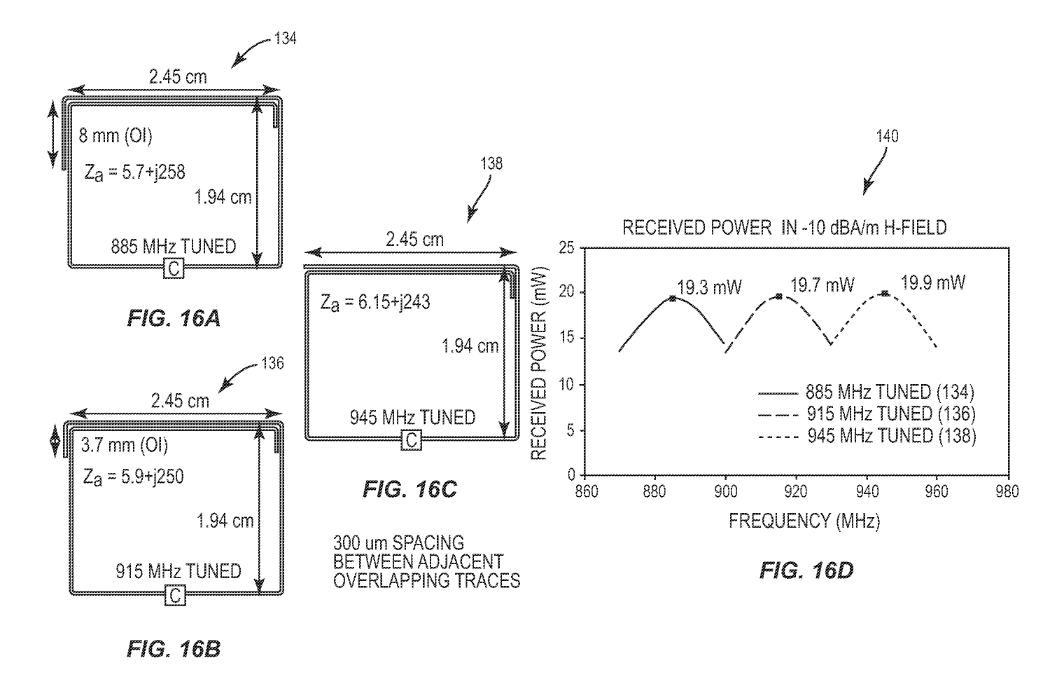

FIGS. 16A-16C are diagrams of other exemplary discontinuous loop antennas 134, 136, 138, respectively, having the same form factor of the discontinuous loop antenna in FIG. 15A tuned for different center frequencies. FIG. 16D is an exemplary plot graph 140 comparing the power couplings of the discontinuous loop antennas 134, 136, 138 in FIGS. 16A-16C, respectively, as a function of frequency. The cut-back points in the discontinuous loop antennas 134, 136, 138 can vary as large as 4 mm for 30 MHz from 885 to 915 MHz or from 915 MHz to 945 MHz, in this example. In addition to tuning the discontinuous loop antennas 134, 136, 138, the discontinuous loop antennas 134, 136, 138 can also be tuned to have their peak coupling response corresponding to the center frequency in the frequency spectrum of that region while being employed for different applications.

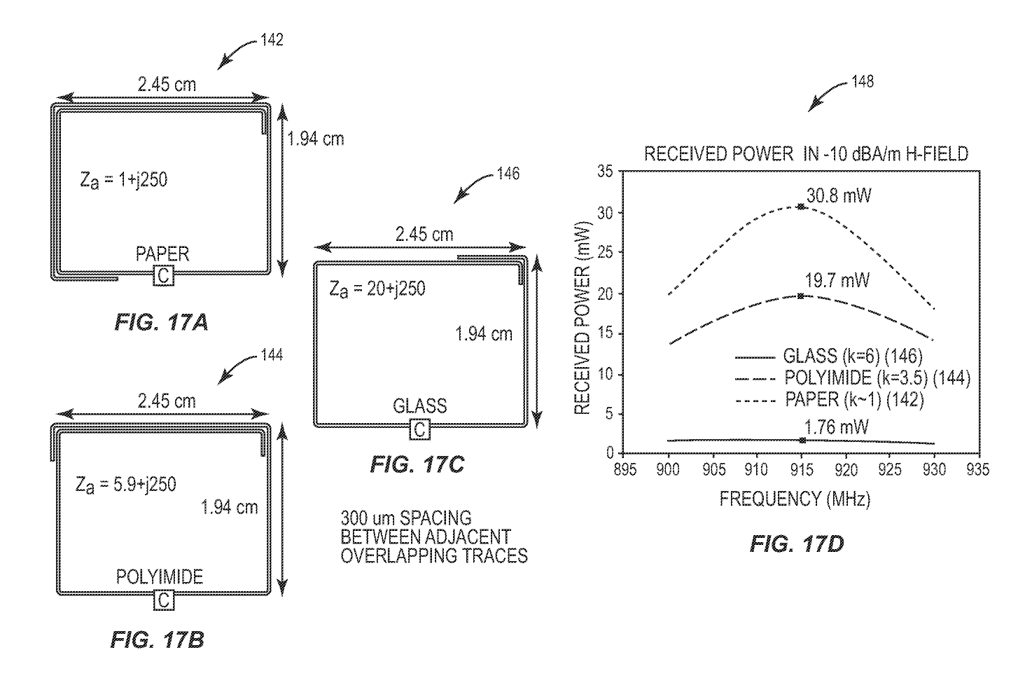

FIGS. 17A-17C are diagrams of other exemplary discontinuous loop antennas 142, 144, 146 having the same form factor of the discontinuous loop antenna 130 in FIG. 15A designed for exemplary applications on different substrate materials. FIG. 17D is an exemplary plot graph 148 comparing the power couplings of the discontinuous loop antennas in FIGS. 17A-17C, respectively, as a function of frequency. For example the peak response of the discontinuous loop antennas 142, 144, 146 can be maintained at 915 MHz in the US, as an example, depending upon the application of the RFID tag, whether it be placed on a paper carton, flexible electronics sheet, or a lossy glass substrate as examples.

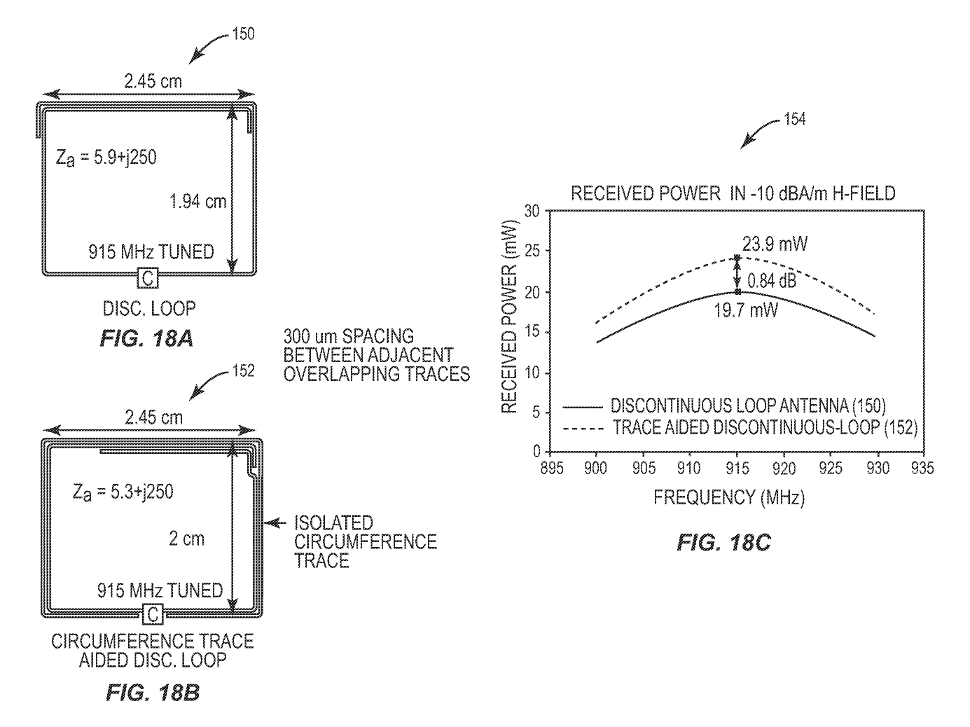

FIG. 18A is a diagram of another exemplary discontinuous loop antenna 150, which may be the discontinuous loop antenna 130 in FIG. 15A and provided for comparison purposes to the discontinuous loop antenna 152 in FIG. 18B. FIG. 18B is a diagram of another exemplary discontinuous loop antenna 152 having improved power coupling using circumference traces. FIG. 18C is an exemplary plot graph 154 comparing the power couplings of the discontinuous loop antennas in FIGS. 18A and 18B, respectively, in a magnetic field. The use of an isolated circumference trace aid is found to improve the power coupling by about 0.8 dB in this example. This is attributed to the enhancement of H-field power coupling by a “loop in a loop” design in this example.

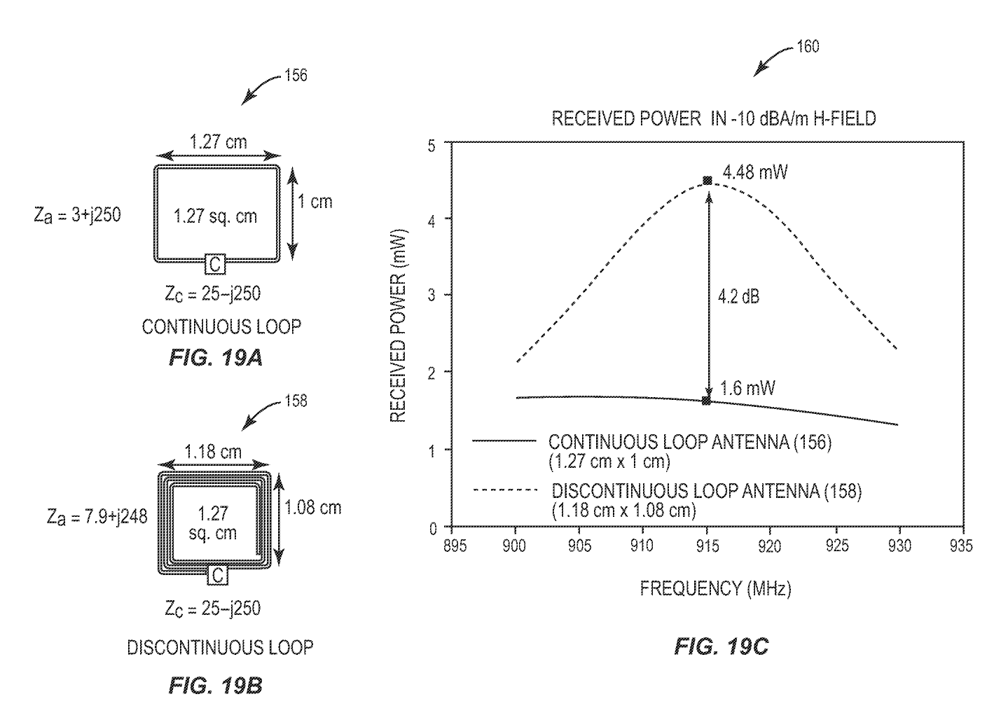

Another class of discontinuous loop antennas is small area discontinuous loop antennas. Due to severe size constraints of some RFID applications, it may be necessary to keep the form factor of the discontinuous loop antenna small, such as close to 1 cm², as an example. In this regard, FIGS. 19A and 19B are diagrams of another exemplary small-sized continuous loop antenna 156 and a discontinuous loop antenna 158, respectively. FIG. 19C is an exemplary plot graph 160 comparing the power couplings of the continuous loop antenna 156 and discontinuous loop antenna 158 in FIGS. 19A and 19B, respectively, in a magnetic field. As can be seen in FIG. 19C, the small size discontinuous loop antenna 158 enjoys 4.5 dB peak higher coupling than the same size continuous loop antenna 156 in this example. This is attributed to an improved impedance match of the discontinuous loop antenna 158 as well as a higher H-field power coupling capability due to a multi-turn loop structure.

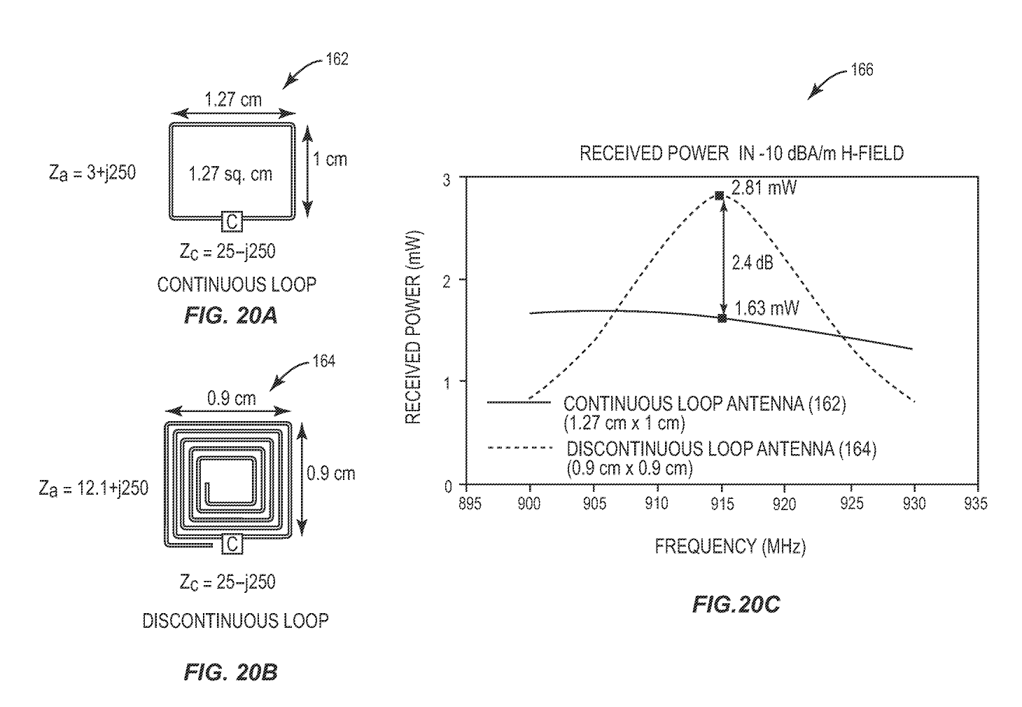

FIGS. 20A and 20B are diagrams of another exemplary small-sized continuous loop antenna 162 and discontinuous loop antenna 164, respectively. FIG. 20C is an exemplary plot graph 166 comparing the power couplings of the continuous loop antenna 162 and the discontinuous loop antenna 164 in FIGS. 20A and 20B, respectively, in a magnetic field. The discontinuous loop antenna 164 can be decreased to less than 1 cm² to yield higher (2.4 dB) peak power coupling. However, the lower band-width effect of the discontinuous loop antenna 164 could result in similar average power over the entire RFID band of operation.

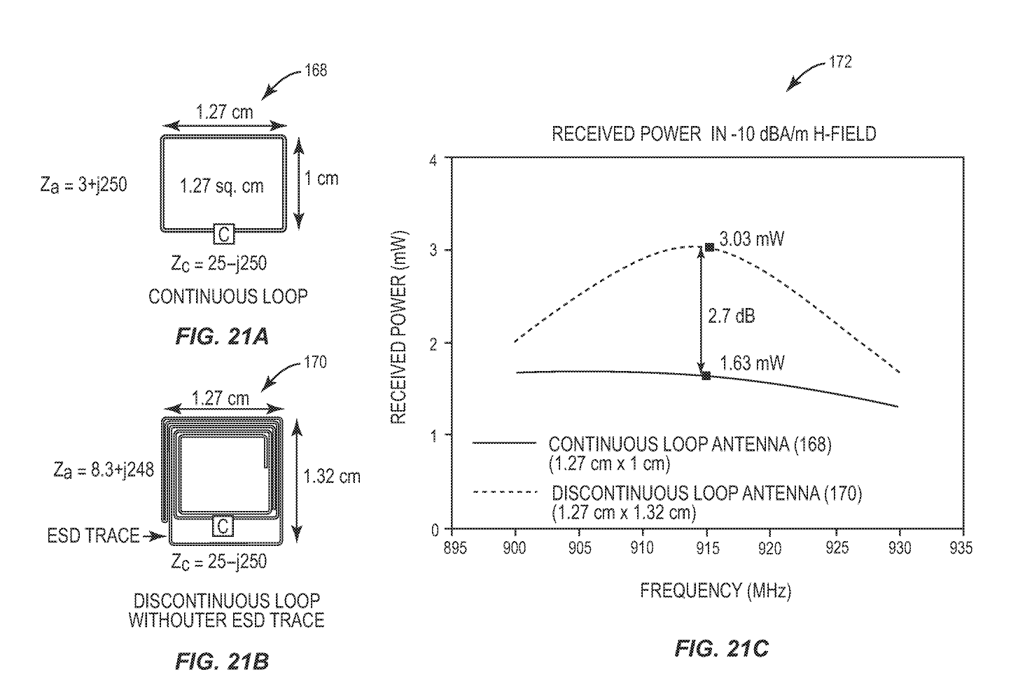

An ESD trace feature could also be included in small-sized discontinuous loop antennas. The ESD feature is for ESD protection purpose, although it should be noted that the possibility of ESD may be minimized due to the closed spaced adjacent traces and the possibility of just touching a single trace are minimal. In the case of small-size discontinuous loop antenna, if it is preferred to have ESD along with small size constraint, an outer ESD trace may be provided in the discontinuous loop antenna. In this regard, FIGS. 21A and 21B are diagrams of other exemplary small-sized continuous loop antenna 168 and a discontinuous loop antenna 170 with outer ESD trace, respectively. FIG. 21C is an exemplary plot graph 172 comparing the power couplings of the continuous loop antenna 168 and discontinuous loop antenna 170 in FIGS. 21A and 21B, respectively, in a magnetic field. As shown in FIG. 21C, a slight increase in real-estate (1.67 sq cm) occupied by the antenna corresponds to a 2.7 dB higher power coupling than for a small size continuous loop antenna.

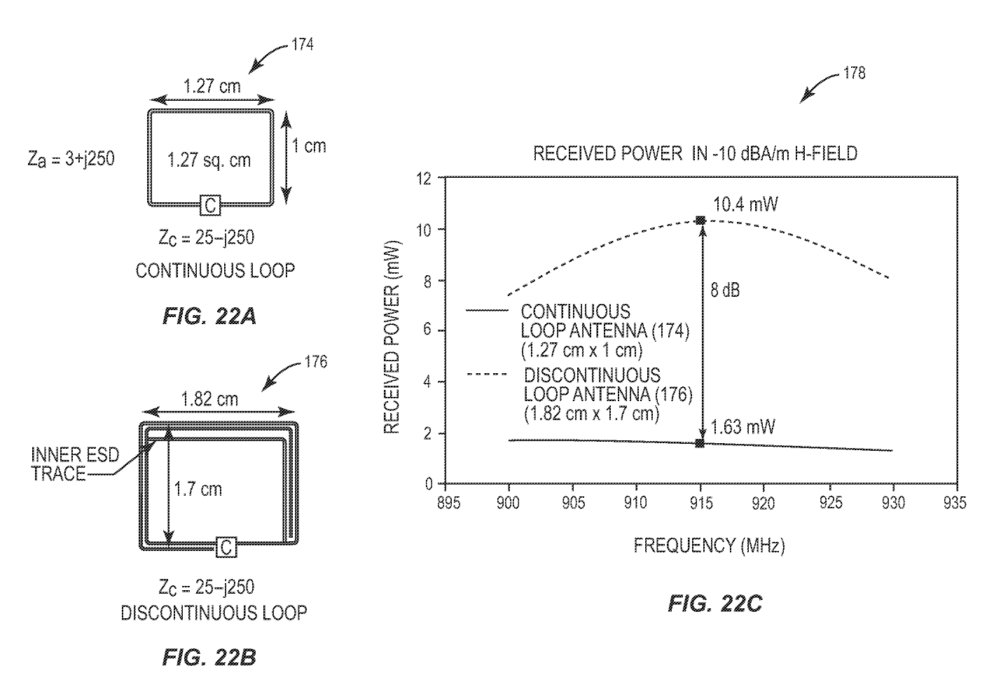

FIGS. 22A and 22B are diagrams of another exemplary small-sized continuous loop antenna 174 and a discontinuous loop antenna 176 with an inner ESD trace, respectively. FIG. 22C is an exemplary plot graph 178 comparing the power couplings of the continuous loop antenna 174 and a discontinuous loop antenna 176 in FIGS. 22A and 22B, respectively, in a magnetic field.

Several methods can be employed to increase the loop area of the discontinuous loop antenna. One exemplary method includes increasing length and/or width of the antenna loop structure. Another exemplary method includes increasing the overlap of the antenna loop structure forming the discontinuity in the discontinuous loop antenna. These methods may be provided during the design phase of the RFID tag. However, because of the discontinuity provided in the discontinuous loop antenna, it is also feasible to change the inductance and corresponding center frequency of the discontinuous loop antenna even after antenna fabrication is complete. The discontinuous loop antenna resonant frequency can be tuned by trimming the discontinuity portion, depending on application.

An embodiment of the present disclosure also includes a radio-frequency identification (RFID) tag, comprising an RFID integrated circuit (IC) chip configured to receive RF power. The RFID tag also comprises a discontinuous loop antenna electrically coupled to the RFID IC chip. The discontinuous loop antenna is configured to collect RF power from a received RF signal, and provide the RF power to the RFID IC chip to power the RFID IC chip. The RFID tag may be a passive or semi-passive RFID tag. The RFID tag may be an active RFID tag. The discontinuous loop antenna can be impedance matched with the RFID IC chip. The discontinuous loop antenna can comprise a loop conductor, and a discontinuity portion disposed in the loop conductor forming a discontinuity capacitor in the loop conductor. The discontinuity capacitor can have less than a capacitance of the RFID IC chip. The RFID tag can be disposed on at least one of a glass medium, a polyimide medium, and a paper medium. The RFID tag can be disposed in liquid or disposed within an RFID tag communication range of a liquid.

The discontinuous loop antenna can be configured to be tuned to a resonant frequency as a function of adjusting the discontinuity portion. The discontinuous loop antenna can be configured to be tuned to a resonant frequency as a function of adjusting discontinuity capacitance of the discontinuity capacitor. The discontinuous loop antenna can be configured to be tuned to a resonant frequency as a function of adjusting the discontinuity portion to change inductance of the loop conductor. The discontinuous loop antenna can have an adjustable impedance configured to be adjusted by adjusting the discontinuity portion. The discontinuity portion can be formed by overlap conductors at an overlap distance from each other disposed in the loop conductor. The discontinuity portion can be formed by gap discontinuity having a gap distance formed in the loop conductor. The discontinuity portion can be formed by a reduced width section of a first width formed in the loop conductor having a second width greater than the first width.

Another embodiment of the present disclosure also includes a method of receiving radio-frequency (RF) signals by a RFID tag antenna of a RFID tag. The method comprises receiving a RF signal through a discontinuous loop antenna comprising a loop conductor and a discontinuity portion disposed in the loop conductor forming a discontinuity capacitor in the loop conductor. The method also comprises providing the RF signal to an RFID IC chip. The method also comprises powering the RFID IC chip with RF energy from the RF signal. The method also comprises demodulating RF communications in the RF signal in the RFID IC chip.

The method may further comprise tuning the discontinuous loop antenna to a resonant frequency as a function of adjusting the discontinuity portion. The method may further comprise tuning the discontinuous loop antenna to a resonant frequency as a function of adjusting discontinuity capacitance of the discontinuity capacitor. The method may further comprise tuning the discontinuous loop antenna to a resonant frequency as a function of adjusting the discontinuity portion to change inductance of the loop conductor. The method may further comprise adjusting the discontinuity portion to adjust impedance of the loop conductor. The method may further comprise tuning a resonant frequency of the discontinuous loop antenna by trimming the loop conductor at a marker disposed in the loop conductor to adjust the discontinuity portion. The method may further comprise tuning a resonant frequency by trimming the loop conductor at a marker disposed in the loop conductor to adjust the discontinuity portion based on a substrate material.

The method may further comprise decreasing a discontinuity capacitance of the discontinuity portion that comprises decreasing an overlap distance between overlapping conductors forming the discontinuity portion. The method may further comprise decreasing a discontinuity capacitance of the discontinuity portion that comprises increasing a gap distance in gap discontinuity forming the discontinuity portion. The method may further comprise decreasing a discontinuity capacitance of the discontinuity portion that comprises decreasing a first width of a reduced width section formed in the loop conductor forming the discontinuity portion, wherein the loop conductor has a second width greater than the first width. The method may further comprise increasing inductance of the loop conductor by increasing a loop area of the loop conductor. Increasing the inductance of the loop conductor may comprise increasing an overlap distance between overlapping conductors forming the discontinuity portion. The method may further comprise adjusting an aspect ratio of the loop conductor to control the relative H-field and E-field sensitivity of the discontinuous loop antenna. The method may further comprise adjusting an impedance of the RFID tag by adjusting the discontinuity portion.

Any functionalities disclosed in any embodiments may be incorporated or provided in any other embodiments with suitable circuitry and/or devices. Although the illustrated embodiments are directed to components, wherein RFID-enabled versions of the components, including ICs and IC chips, employ passive RFID tags, further embodiments include one or more semi-passive or active RFID tags depending upon the particular functionality of the RFID tag system desired. For example, the discontinuous loop antennas disclosed herein may be included in devices as part of or apart from RFID tags and included or not included in a RFID system, and that include, without limitation, a set top box, an entertainment unit, a navigation device, a communications device, a personal digital assistant (PDA), a fixed location data unit, a mobile location data unit, a mobile phone, a cellular phone, a computer, a portable computer, a desktop computer, a processor-based device, a controller-based device, a monitor, a computer monitor, a television, a tuner, a radio, a satellite radio, a music player, a digital music player, a portable music player, a video player, a digital video player, a digital video disc (DVD) player, and a portable digital video player.

The RFID tags or other load devices having discontinuous loop antennas can be employed in any application desired, including but not limited to electrical connectors, medical devices, fluid couplings, beverage dispensing containers, industrial controls, environmental monitoring devices, connection of consumer electronics, electronics assemblies and subassemblies, containers and lids, doors and doorframes, windows and sills, pharmaceutical containers, medical devices, beverage containers, apparel, credit cards, and many other applications.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A discontinuous loop antenna, comprising:
a loop conductor; and
a discontinuity portion disposed in the loop conductor forming a discontinuity capacitor in the loop conductor.

2. The discontinuous loop antenna of claim 1, comprising a single discontinuous portion in the loop conductor.

3. The discontinuous loop antenna of claim 1, wherein the loop conductor is comprised of a single loop turn.

4. The discontinuous loop antenna of claim 1, wherein the loop conductor is comprised of a plurality of loop turns.

5. The discontinuous loop antenna of claim 1 wherein the loop conductor is comprised of at least one circumferential trace.

6. The discontinuous loop antenna of claim 1 configured to be tuned to a resonant frequency as a function of adjusting the discontinuity portion.

7. The discontinuous loop antenna of claim 6 configured to be tuned to at least one of the following center frequencies: 885 MHz, 915 MHz, and 945 MHz.

8. The discontinuous loop antenna of claim 1 configured to be tuned to a resonant frequency as a function of adjusting discontinuity capacitance of the discontinuity capacitor.

9. The discontinuous loop antenna of claim 1 configured to be tuned to a resonant frequency as a function of adjusting the discontinuity portion to change inductance of the loop conductor.

10. The discontinuous loop antenna of claim 1, further comprising at least one marker disposed in the loop conductor to indicate at least one trimming point of the loop conductor to adjust the discontinuity portion to tune a resonant frequency of the loop conductor.

11. The discontinuous loop antenna of claim 1 having an adjustable impedance configured to be adjusted by adjusting the discontinuity portion.

12. The discontinuous loop antenna of claim 1, wherein the discontinuity portion is formed by overlap conductors at an overlap distance from each other disposed in the loop conductor.

13. The discontinuous loop antenna of claim 1, wherein the discontinuity portion is formed by gap discontinuity having a gap distance formed in the loop conductor.

14. The discontinuous loop antenna of claim 1, wherein the discontinuity portion is formed by a reduced width section of a first width formed in the loop conductor having a second width greater than the first width.

15. The discontinuous loop antenna of claim 1, wherein the discontinuity portion is formed by at least one inter-digitated portion.

16. The discontinuous loop antenna of claim 1, wherein the loop conductor is comprised of:
a first conductor of a first length, the first conductor having a first end configured to be electrically coupled to a first antenna node and a second end portion of a second length disposed at a second end;
a second conductor of a first length, the second conductor having a first end configured to be electrically coupled to a second antenna node and a second end portion of a second length disposed at a second end; and
the first conductor and the second conductor arranged in an enclosed loop formation to form a loop conductor area inside the enclosed loop formation having a loop conductor inductance; and
wherein the discontinuity portion is formed by a discontinuity between the second end portion of the first conductor and the second end portion of the second conductor disposed at a gap distance to form the discontinuity capacitor in the loop conductor.

17. The discontinuous loop antenna of claim 1, further comprising at least one electrostatic discharge (ESD) shunt coupled to the loop conductor.

18. The discontinuous loop antenna of claim 17, wherein the at least one ESD shunt is comprised of at least one of: a first ESD shunt disposed inside the loop conductor, and a second ESD shunt disposed outside the loop conductor.

19. The discontinuous loop antenna of claim 1 impedance matched with another circuit.

20. The discontinuous loop antenna of claim 1 disposed on at least one of a glass medium, a polyimide medium, and a paper medium.
